(19) United States
(12) Patent Application Publication
(10) Pub. No.: US 2018/0240209 A1
(43) Pub. Date: Aug. 23, 2018

(54) INTELLECTUAL PROPERTY INFORMATION SYSTEM

(71) Applicant: Wesley Malherek, Maple Lake, MN (US)

(72) Inventor: Wesley Malherek, Maple Lake, MN (US)

(21) Appl. No.: 15/435,298

(22) Filed: Feb. 17, 2017

(51) Int. Cl. G06Q 50/18; G06Q 10/10; G06F 17/30

(52) U.S. Cl. CPC G06Q 50/184; G06F 17/30882; G06Q 10/10

(57) ABSTRACT

An intellectual property information system is provided. The system comprises a word processing portion. The system further comprises an office action viewing portion comprising a cited reference link configured to be activated by a user. In response to activation a summary of the cited reference link is generated. The word processing portion, office action viewing portion and the summary are generate by a processor of a computing device and displayed on a display.

### CROSS-REFERENCE TO RELATED APPLICATIONS

The present application is based on and claims the benefit of U.S. Provisional Patent Application Ser. No. 62/296,557 filed Feb. 17, 2016, the content of which is hereby incorporated by reference in its entirety.

### BACKGROUND

Patent prosecution has become a major field of law. However, prosecuting a patent can be very arduous. When prosecuting a patent, there are many hurdles to overcome some of these include rejections, objections, restrictions. Not every hurdle is the same and some are easier than others. Currently there is no way of easily looking back at past performance in the patent office to allow for predictions of future patent office behavior.

### SUMMARY

An intellectual property information system is provided. The system comprises a word processing portion. The system further comprises an office action viewing portion comprising a cited reference link configured to be activated by a user. In response to activation a summary of the cited reference link is generated. The word processing portion, office action viewing portion and the summary are generate by a processor of a computing device and displayed on a display.

These and various other features and advantages that characterize the claimed embodiments will become apparent upon reading the following detailed description and upon reviewing the associated drawings.

### BRIEF DESCRIPTION OF THE DRAWINGS

FIG. 1 illustrates a block diagram of an intellectual property information and analysis system.

FIG. 2 illustrates a method of gathering USPTO rejection data in accordance with an embodiment of the present invention.

FIG. 3 illustrates a login interface in accordance with an embodiment of the present invention.

FIG. 4 illustrates a home interface of an IP information system in accordance with an embodiment of the present invention.

FIG. 5 illustrates a search interface in accordance with an embodiment of the present invention.

FIG. 6 illustrates a rejection viewing interface in accordance with an embodiment of the present invention.

FIG. 7 illustrates a document viewing interface in accordance with an embodiment of the present invention.

FIG. 8 illustrates a reference page in accordance with an embodiment of the present invention.

FIG. 10A illustrates an examiner page in accordance with an embodiment of the present invention.

FIG. 11 illustrates a method of data analysis in accordance with an embodiment of the present invention.

FIG. 12 illustrates a method of processing office communications in accordance with an embodiment of the present invention.

FIG. 13 illustrates a rejection identification in accordance with an embodiment of the present invention.

FIG. 14 illustrates claim identification in accordance with an embodiment of the present invention.

FIG. 15 illustrates a method of genericizing an office communication in accordance with an embodiment of the present invention.

FIG. 16 illustrates a word processor in accordance with an embodiment of the present invention.

FIG. 17 illustrates a claim word processor select menu in accordance with an embodiment of the present invention.

FIG. 18 illustrates a snippet menu in accordance with an embodiment of the present invention.

FIG. 19 illustrates an autocomplete feature in accordance with an embodiment of the present invention.

FIG. 20 illustrates a reference select menu in accordance with an embodiment of the present invention.

FIG. 21 illustrates a reference aide in accordance with an embodiment of the present invention.

FIG. 22 illustrates a reference page in accordance with an embodiment of the present invention.

FIG. 23 illustrates a method of generating an aide in accordance with an embodiment of the present invention.

FIG. 24 illustrates a firm page in accordance with an embodiment of the present invention.

FIG. 25 illustrates a new office communication page in accordance with an embodiment of the present invention.

FIG. 26 illustrates a response generator in accordance with an embodiment of the present invention.

FIG. 27 illustrates an agent performance page in accordance with an embodiment of the present invention.

FIG. 28 illustrates a patent representative search in accordance with an embodiment of the present invention.

FIG. 29 illustrates a patent representative's page in accordance with an embodiment of the present invention.

FIG. 30 illustrates a block diagram showing one embodiment of a computing environment that can be used in the architectures shown in the previous Figures.

### DETAILED DESCRIPTION OF ILLUSTRATIVE EMBODIMENTS

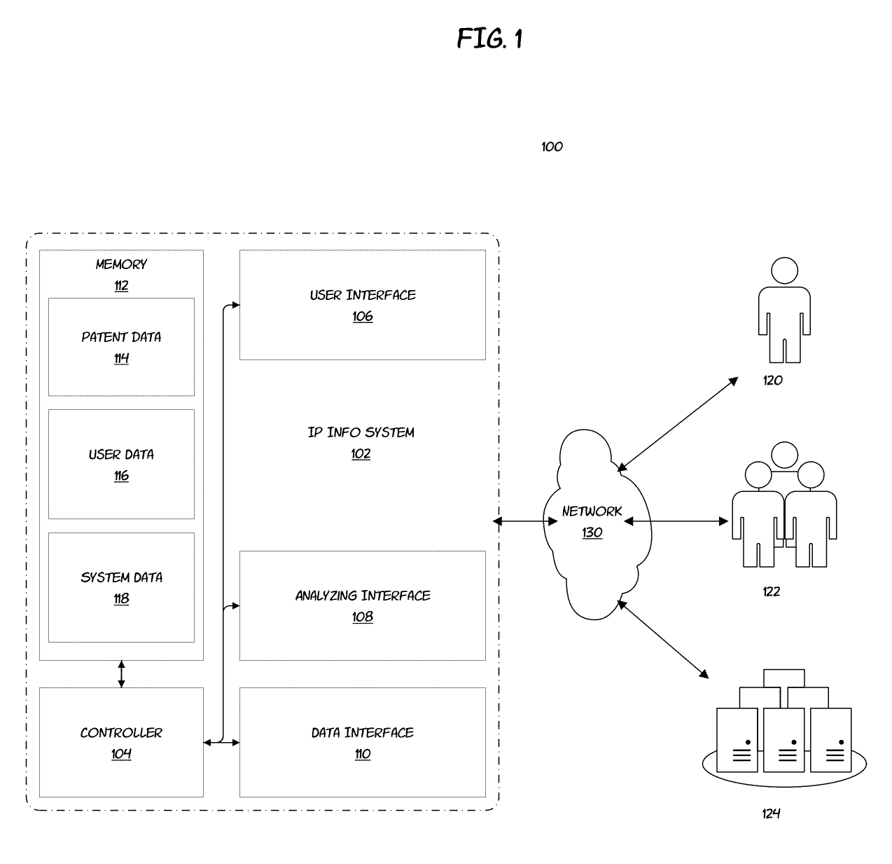

FIG. 1 illustrates a block diagram of an intellectual property information and analysis system. IP information system 102 comprises controller 104, user interface 106, analyzing interface 108 and data interface 110. Controller 104 accesses memory 112. Controller 104 can access patent data 114, user data 116 and system data 118.

Patent data 114 may comprise any patent related information. This includes all patent text, application bibliographic data, image file wrapper data, text of files in the file wrapper, etc. User data 116 may comprise any user related information. This includes user statistics, saved settings, assigned cases, drafts, bibliographic information, history, messages, comments, snippets, boilerplates, legal standards, etc. System data 118 may comprise all other data to allow the system to function, including an operating system, device drivers, server applications, etc.

Controller 104 stores and retrieves data utilizing the data interface 110. Controller 104 analyzes the data using the analyzing interface 108. Analyzing may comprise, compiling statistics, classifying text, detecting trends and many more operations detailed below. User interface 106 is how users 120-124 interact with IP info system 102. User interface 106 may be accessed through network 130. Many types of users can access IP info system including an individual 120, organizations 122 and enterprises 124.

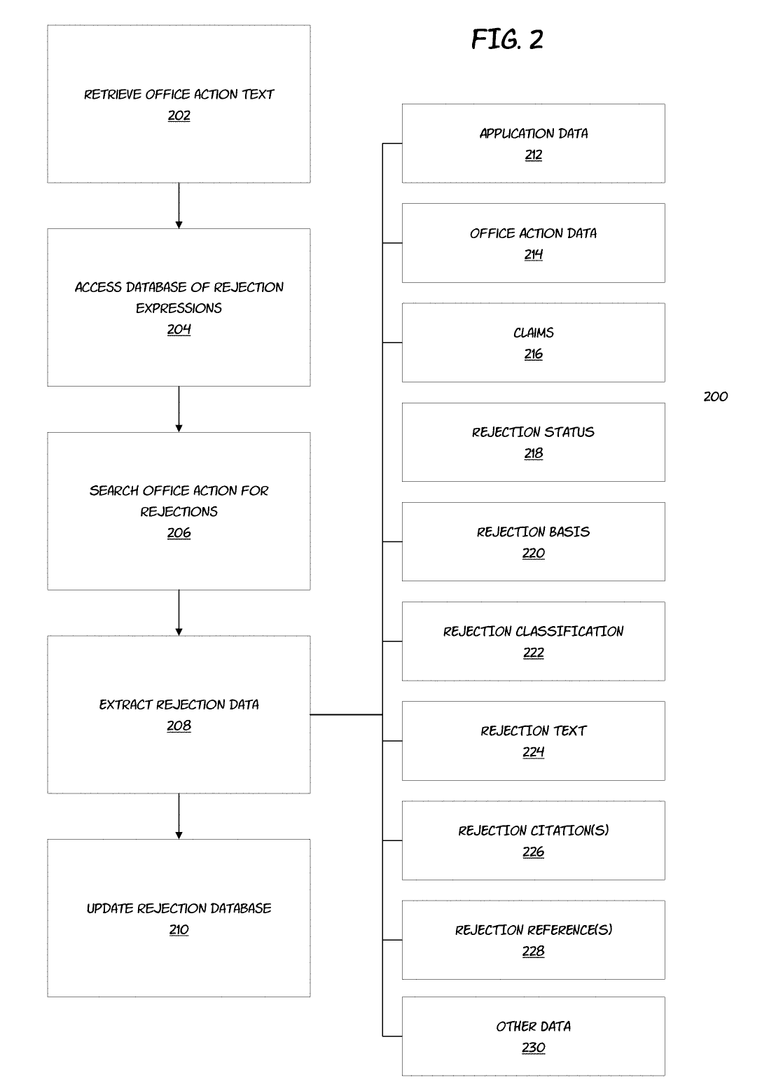

FIG. 2 illustrates a method of gathering USPTO rejection data. In block 202, office action text is retrieved. The office action text may be retrieved from a variety of sources. The text may be generated through Optical character recognition from USPTO images. The text may be retrieved from a source of office action texts, which may be the USPTO in the future.

In block 204, a database of rejection expressions is accessed. A rejection expression may be a regular expression. In one embodiment, the rejection expressions are from MPEP 706, Rejection of Claims. In other embodiments, the rejection expressions are algorithmically generated from past human analyzed office actions.

In block 206, the office action text is searched to identified rejections, objections, allowances and/or informalities. The searching may be done by an analyst. The searching may be done through a regular expression search utilizing the rejection expressions.

In block 208, rejection data is extracted. Some data may be inherited from the application, such as, examiner, art unit, international class, etc., this is application data 212. Some data may also be inherited from the office action, such as, date, finality, action count, etc., this is office action data 214. Claims 216 are the claims that were rejected under the given rejection. Rejection status 218 is whether or not the rejection was eventually overcame, still pending, upheld, appeal overturned, etc. Rejection basis 220 is the statutory or non-statutory, for example 35 U.S.C. 102(a) or non-statutory double patenting. Rejection classification 222 is one of the most complex data sets.

Rejection classification 222 can be classified in many different ways. In one embodiment, the classifications come from MPEP 706, each correlated to a paragraph of MPEP 706. In another embodiment, classes of rejection classification 222 come from an analysis of all rejections and breaking them down into similar types of rejections.

Rejection text 224 is simply the text of the rejection. This text may be indexed for string text searching, for example, a user could search for a reference name and find a rejection that had cited the same reference. Rejection citation(s) 226 are the legal authority or authorities cited to support the rejection. These authorities may be the MPEP. Other authorities often cited are court cases and statutes. In more rare cases other legal authorities may be cited such as treatises, USPTO documents/guidelines, legal journals, expert opinions, etc. Rejection reference(s) 228 are the references used to support the rejection. References are most commonly used in anticipation and obviousness rejections, however, references may be used in other rejections as well. References 228 may be patent publications, patents or other art as defined under 35 U.S.C. 102. However, in the future references may be expanded to include other pieces of art.

Other data 230 may also be extracted from the rejection. Other data 230 includes the patent agent who responded prior to the rejection or agent who replied to the rejection. Other data 230 may also include any information on an applicable appeal, i.e. if the rejection was appealed and what happened during the appeal process. Other data 230 may also include rejection family data, for example, if the rejection is upheld from a previous office action it will be linked to the rejection from the previous action. Other data 230 may also include alternate data, for example, if a rejection is in the alternate to another rejection this data will be saved. The alternate rejection commonly occurs in an example similar to the following, “Claim 1 is anticipated by Reference X or in the alternative is non-obvious in view of Reference X.” These are examples of other data 230, however, other data 230 may be any data that corresponds to a characteristic of a rejection.

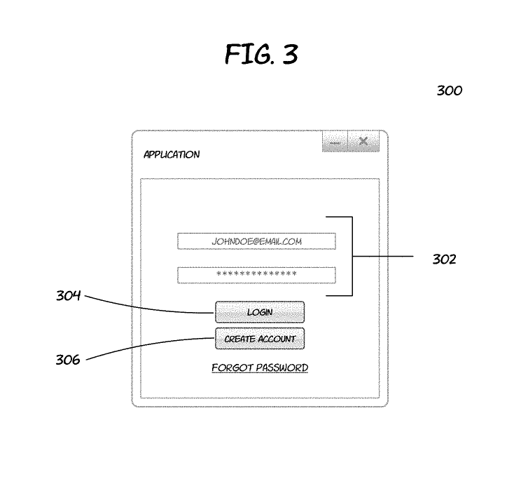

FIG. 3 illustrates a login interface in accordance with an embodiment of the present invention. Login window 300 comprises various components. Section 302 represents a username box and a password box. Button 304 is a login button. Button 306 is a create account button.

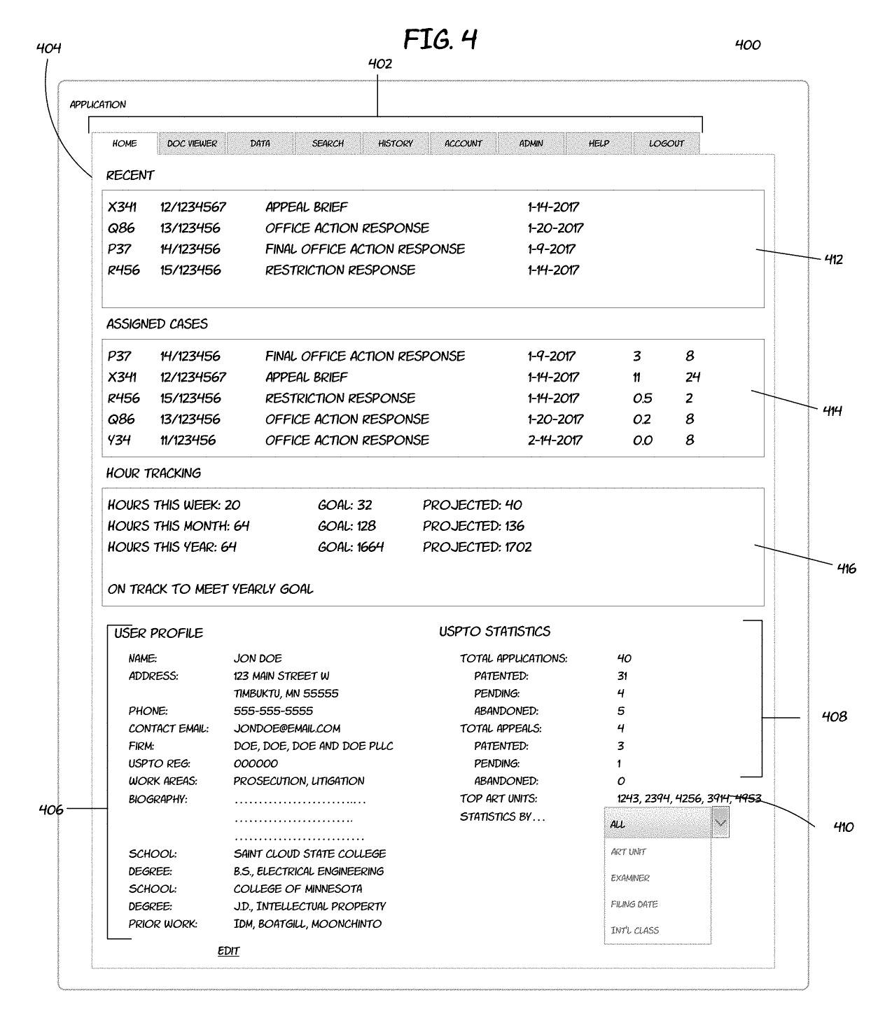

FIG. 4 illustrates a home interface of an IP information system in accordance with an embodiment of the present invention. Application 400 can comprise a variety of modules. Environment selector 402 comprises various buttons to a variety of environments. Environment selector 402 in the embodiment of FIG. 4 comprises buttons for home, document viewing, data viewing, searching, history, account management, administration, help and logout. Other embodiments, may comprise fewer or greater amounts of tabs.

Window 404 comprises an example of a home screen. In one embodiment, the home screen comprises a user profile 406, recent cases 412, assigned cases 414 and hour tracking 416. Recent cases 412 may show the most recent applications worked on or viewed. Working on an application may include, drafting an office action response, drafting an application, reviewing an application, searching cited references/authority, etc. The recent cases 412 shows information for a user to easily identify the case, examples of information may be docket number, application number, assignee, status, date, etc. In one embodiment, the recent case 412 information shown can be chosen by the user. Assigned cases 414 displays the cases that have been assigned to the user that is logged in. Assignments may be made by the user, an administrator, a partner, an automatic docketer, etc.

Hour tracking 416 tracks the hours the user is working. Hour tracking 416 may show allow the user to enter manually add hours. In one embodiment, hour tracking 416 shows hours automatically tracked while using the IP info system. In one embodiment, tracked hours may be tracked only while a user has a word processing window open or a reference viewing window.

A user profile 406 may contain biographic information as shown. User profile 406 may also contain any other information identifying or specific to the current user. Window 404 may also comprise USPTO statistics 408. As shown the statistics 408 show statistics of the current user. The statistics 408 may be controlled by a dropdown menu 410. Dropdown menu 410 as shown has all, art unit, examiner, filing date and international class. Choosing one of these options would show the statistics 408 based on the filter selected.

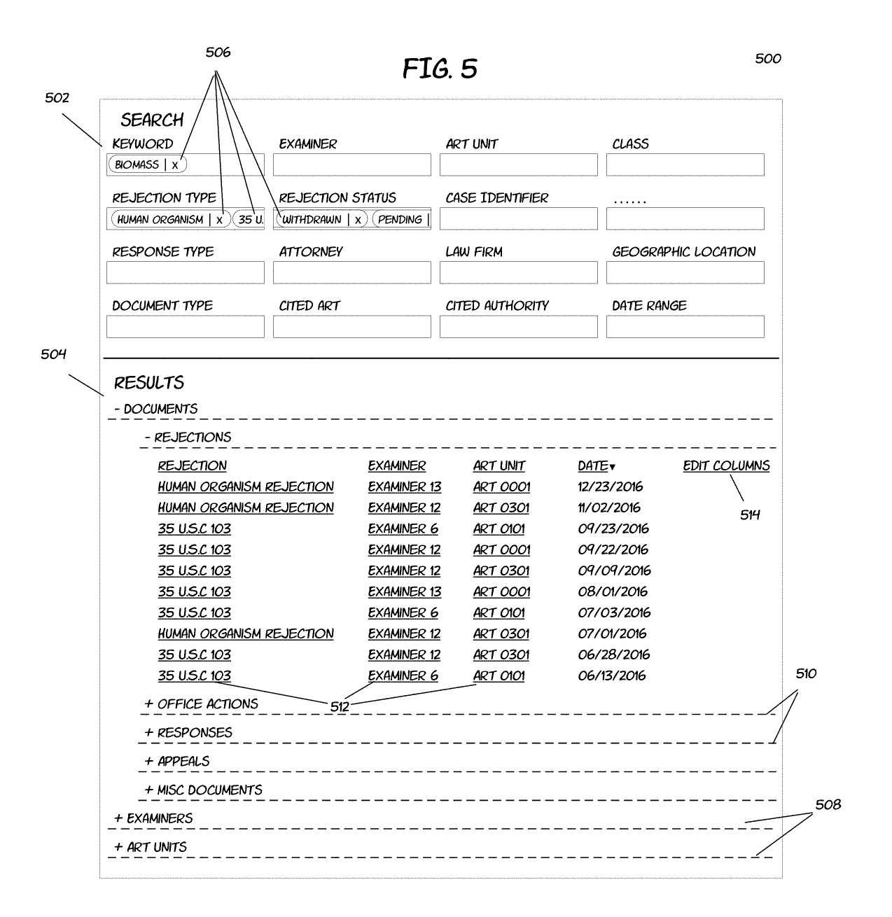

FIG. 5 illustrates a search interface in accordance with an embodiment of the present invention. Search interface 500 comprises an input section 502 and a result section 504. Input section may include various input areas including but not limited to the inputs as shown. In one embodiment typing a phrase in the inputs will generate a tag 506. Tags 506 can have an autocomplete feature to ensure a user will have desirable results. A user may add several tags to each input box. In one embodiment, the input areas are Select2 jquery select boxes. Only a few search inputs are shown in FIG. 5. Many other types of inputs can be shown here such as assignee, inventor or any bibliographic data of the application as shown on PAIR. In one embodiment, the input boxes could be combined into one box allowing the search terms to search all bibliographic data of a rejection, examiner, application, etc. As shown in FIG. 5 the case identifier input is a combined input box that searches all case identifiers, including patent number, application number, publication number, docket number, etc.

Results section 504 is where the results of the search based on input from the input section 502 are displayed. Results can be broken down into categories 508. Examples of categories 508 may be documents, examiners, art units, classes, etc. Results can further be broken down into subcategories 510. Examples of subcategories 510 under the document category 508 are office actions, appeals, responses, rejections, and any other patent prosecution document. Not all categories 508 will need subcategories 510 and some subcategories 510 could have more subcategories 510 under them. Results can be shown with more or less data organized into columns 512. Columns 512 will vary based on the category 508 they are under. For example, if a user is under the examiner category, specific rejection columns will not show. Columns 512 may also vary based on the search input. For example, if a user has filled in the examiner input a column 512 for examiner will show. A user may manually override what columns 512 will show under results by selecting the edit columns button 514. Some unique columns a user could add are docket numbers, application number, assignee, etc.

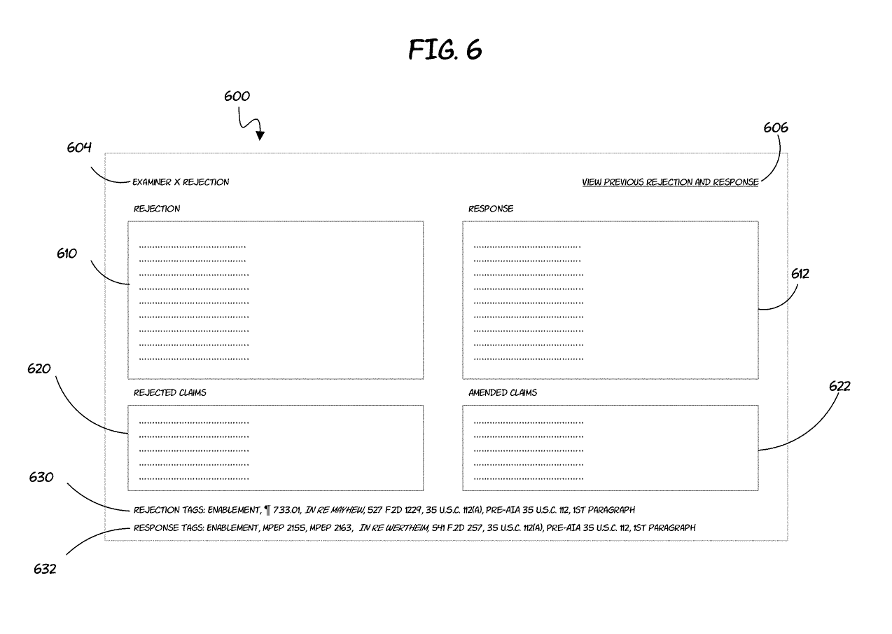

FIG. 6 illustrates a rejection viewing interface in accordance with an embodiment of the present invention. Document title 604 is a title of the rejection. Title 604 may be given by a user or it may be generated automatically based on characteristics of the rejection. Characteristics include, but are not limited to, examiner name, art unit, int'l class, legal justification (101, 102, etc), date, rejection classification, etc.

Strategic link 606 provides a strategic link related to the current document. Strategic link 106 may be a link to the previous rejection or previous office action. Strategic link 606 may be a link to the subsequent rejection or subsequent office action. Strategic link 606 may be a link to statistics of the examiner, art unit, int'l class or other statistic pages. Strategic link 606 may be a link to the full texts of the authorities cited by either the examiner or patent agent. Strategic link 606 may comprise more than one link. These are just some example of strategic links 606 that may be provided.

Rejection text 610 is a textbox where the text of a rejection is displayed. The text is searchable and copy-able. Proximate the rejection text 610 are the rejected claims 620. The rejected claims 620 are the claims rejected by rejection text 610. For example, the rejection in rejected claims 620 might reject claims 1, 4, 5 and 10, in which case the rejected claims will only show claims 1, 4, 5 and 10. It is possible that rejected claims 620 would show more or fewer claims than the specific claims rejected by the rejection text 610. Rejection tags 630 comprise identifying tags of the rejection text 610. Identifying tags may include; statutory basis, legal authority cited, classified reasoning or other characteristics of the rejection.

Response text 612 is a textbox where the text of a response is displayed. The text is searchable and copy-able. Proximate the response text 612 are the amended claims 622. The amended claims 622 are the claims rejected by rejection text 610. For example, the rejection in rejected claims 620 might reject claims 1, 4, 5 and 10, in which case the amended claims 622 will only show claims 1, 4, 5 and 10. It is possible that amended claims 622 would show more or fewer claims than the specific claims rejected by the rejection text 610. Response tags 632 comprise identifying tags of the response text 612. Identifying tags may include; statutory basis, legal authority cited, classified reasoning or other characteristics of the rejection. Although the term rejection has been used, any objection or action against an application could be interchanged. The components of other embodiments may be similar to the components of FIG. 6 except that they are in relation to an office action and not a single rejection.

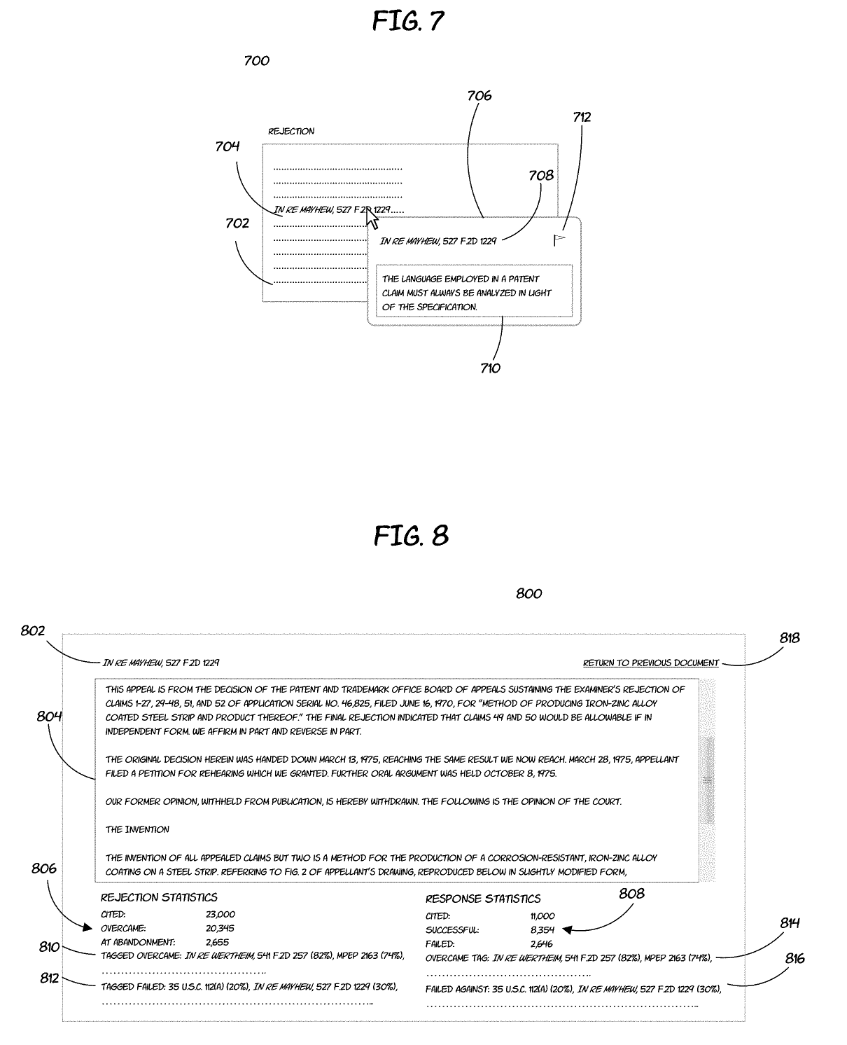

FIG. 7 illustrates a document viewing interface in accordance with an embodiment of the present invention. Document viewing window 702 is where a document's text is displayed. The document viewing window 702 may be highlight-able or copy-able. Located within the text of document viewing window 702 is a reference 704. When the reference 704 is activated a pop-up window 706 is generated. Activation can be a variety of actions, for example but not limitation, hover, focus or click.

Pop-up window 706 comprises a title 708 and a body 710. Title 708 is the name of the reference cited and the citation. Title 708 can comprise any identifier of the reference 704. Body 710 comprises the text of the reference 704. Body 710 ideally comprises the most relevant text of the reference 704, which was used to support whatever statement the document cited reference 704 for. Body 710 could also comprise a summary of the reference 704, either computer or human generated. Pop-up window 706 can also comprise reference indicator 712. Reference indicator 712 is an indicator of whether or not the reference 704 is still “good law.” Clicking on reference 704 may also cause a direction to the reference's page.

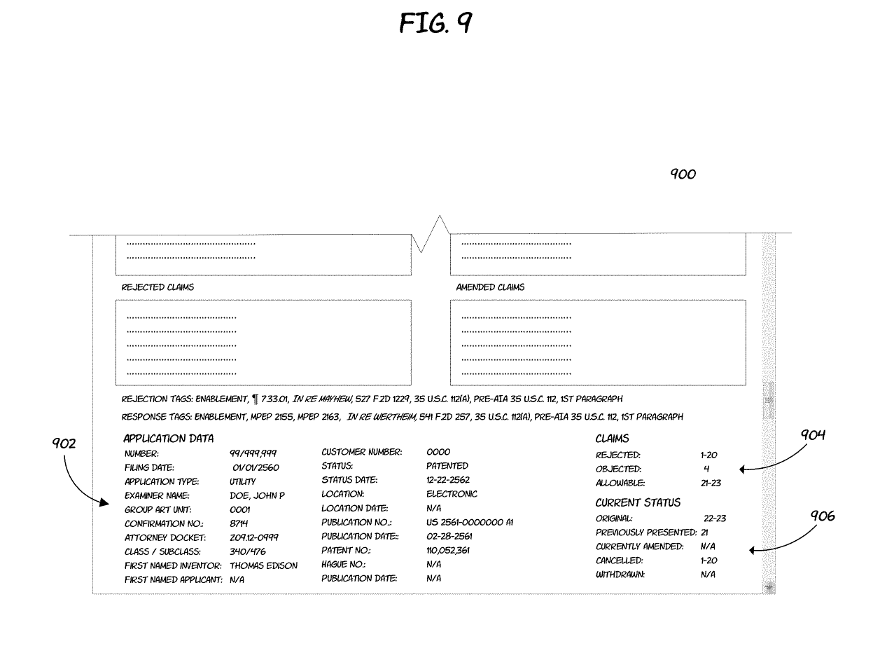

FIG. 8 illustrates a reference page in accordance with an embodiment of the present invention. Title 802 is the title of the document shown. Text 804 is the text of the document. Text 804 may be scrollable, highlightable and/or copyable. Text 804 might have text pre-highlighted, relevant to the page that directed a user to reference page 800. Text 804 may be the document in its entirety or a specific segment of the document.

Reference page 800 may also comprise rejection statistics 806. Rejection statistics 806 includes statistics of rejections that cite the reference of reference page 800. Statistics 806 may include the number of times the rejections the reference was cited in. Statistics 806 may also include the number of times the rejections the reference was cited in were overcame, avoided (through amendment) and/or present at abandonment.

Also in rejection statistics 806 can be failed tags 812 and/or overcame tags 810. When a reference is cited in a document, the document is tagged with the reference. In this context overcame tags 810 are the tags of responses that overcame a rejection citing the document of document page 800. Similarly failed tags 812 are the tags of responses that failed to overcome the rejection citing the document of document page 800. Also alongside the overcame tags 810 and failed tags 812, can be the percentage the response with that tag failed or overcame. Also alongside the tags 810 and/or 812 can include an indication of the reference being “good law.”

Reference page 800 may also comprise response statistics 808. Response statistics 808 includes statistics of rejections that cite the reference of reference page 800. Statistics 808 may include the number of times the reference was cited in a response. Statistics 808 may also include the number of times the reference was cited in a response and the rejection was overcame, avoided (through amendment) and/or present at abandonment.

Also in rejection statistics 808 can be failed tags 816 and/or overcame tags 814. When a reference is cited in a document, the document is tagged with the reference. In this context overcame tags 814 are the tags of rej ections that were overcome by a response citing the document of document page 800. Similarly failed tags 816 are the tags of rejections that were failed to overcome by a response citing the document of document page 800. Also alongside the overcame tags 814 and failed tags 816, can be the percentage the response with that tag failed or overcame. Also alongside the tags 814 and/or 816 can include an indication of the reference being “good law.”

FIG. 1E illustrates a reference page in accordance with an embodiment of the present invention.

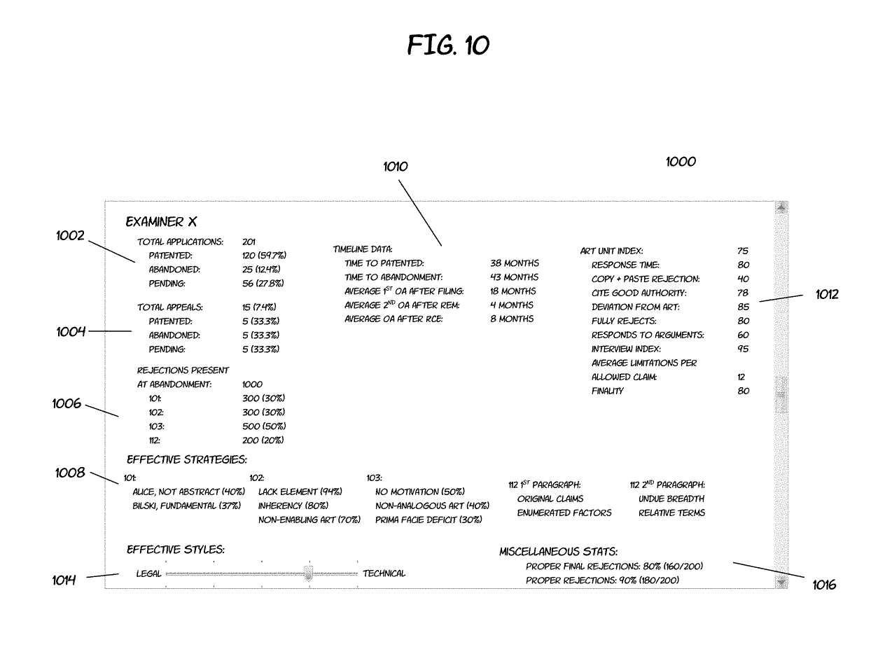

FIG. 10A illustrates an examiner page in accordance with an embodiment of the present invention. Examiner page 1000 comprises application section 1002, appeal section 1004, rejection section 1006, strategy section 1008, timeline section 1010, index section 1012, style section 1014 and miscellaneous section 1016. Application section 1002 comprises basic information on the applications the examiner has worked on. Application section 1002 may comprise the total number of applications as well as the total patented and the total abandoned applications.

Appeal section 1004 comprises basic information on the appeals the examiner has worked on. Appeal section 1004 may comprise the total number of appeals as well as the total patented and total abandoned appeals. Appeal section 1004 may also comprise how often the examiner is affirmed vs reversed by the board. Appeal section 1004 may also show how far an appeal process normally runs, either from step 1: notice of appeal to the last step of a board decision. This is useful because some examiner's will retract a rejection if an appeal is filed and never fully complete a full appeal to a board decision.

Rejection section 1006 comprises basic information on the rejections the examiner gives. As shown in FIG. 10 the rejections present at abandonment are shown; this information is useful to a user because it shows which rejections an examiner gives that cannot be overcome. Rejection section 1006 may also comprise the total number of rejections given by the examiner as well as the statistics broken down by rejection type (101, 102, 103, 112, MPEP 701 paragraphs, etc.)

Strategy section 1008 comprises information relating to strategies used against the examiner in past office communications. As shown in FIG. 10, five basic rejections are listed with the most effective strategies used against the examiner to overcome the rejection. In other embodiments, every type or rejection possible is listed with the statistics of all responses are shown (even the ineffective strategies, which may be useful to avoid). The top rejections shown may be automatically selected based on the cases the user is assigned to or is working on. The top rejections may also be selected by the user and saved as a global or lower level setting.

Timeline section 1010 comprises information relating to the average timeline of the examiner. This information may be useful for future docketing purposes and can be accounted for by an automatic docketing system. This information is also commonly desired by a client.

Index section 1012 comprises index scores of the examiner. Index scores can be compiled by taking various metrics of the examiner. In one embodiment, these scores are weighted against all other examiners. In one embodiment, these scores are weighted against other examiners in their art unit or international class. Some examples of metric scores are shown.

The response time metric may take into account many aspects of how long it takes an examiner to respond to an office communication. The copy and paste rejection metric may analyze all rejections ever given by the examiner and calculate an average distance from one another. The cite good authority metric may analyze all authority cited by the examiner and cross reference a database that has the dates authority became overruled or “bad” law. The deviate for art index may generically compare all stats of the examiner with the average stats of other examiners in their art unit. The fully rejects index may represent what percent of the time an office action was properly made final or not. The responds to arguments index may analyze office actions subsequent to a response and determines if the examiner fully responded to the arguments presented. The interview index takes into account how often the examiner interviews and how effective they were, for example by seeing a correlation between interviews and grants. The allowed claim index may be representative of how often the examiner gives allowable claims immediately. The average limitations per allowed claims is indicative of how long each claim allowed by the examiner is. Limitations may be calculated in a variety of ways including, word count, words weighted by limitation, part of speech analysis, natural language processing and other types of processing.

Style section 1014 may comprise sliders that are indicative of the examiners style as correlated from their past work. For example as shown, a slider shows if the examiner presents more legal arguments or more technical arguments. This slider may also represent which arguments the examiner responds to. Miscellaneous section 1016 may comprise any other stat calculated from analysis of the examiner's record.

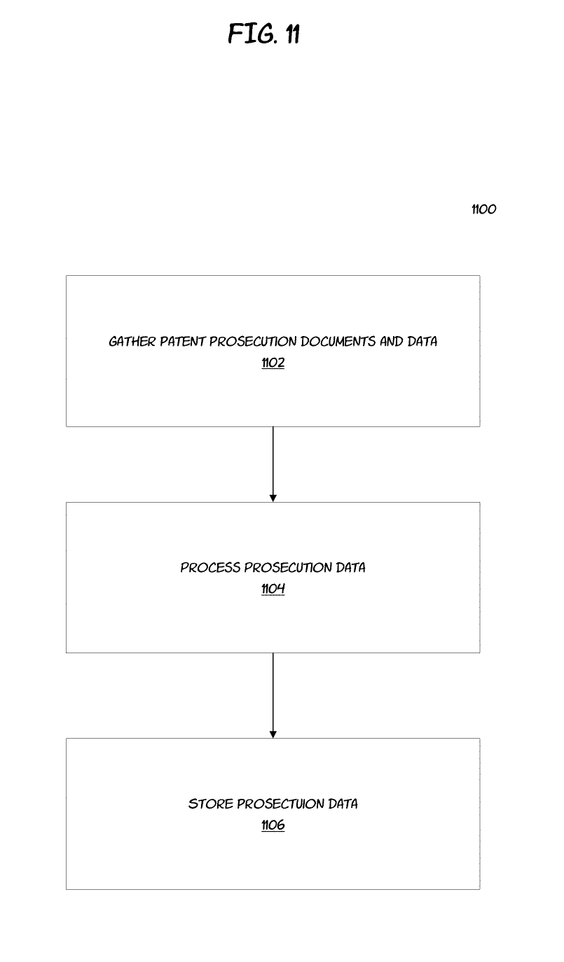

FIG. 11 illustrates a method of data analysis in accordance with an embodiment of the present invention. Method 1100 comprises, gather documents and data, process data and storing data. At block 1102 the documents and data are gathered. The documents and data may be obtained directly from the USPTO. The documents and data may be obtained from another secondary source. Documents that may be gathered are any in the prosecution history, mostly those in the documents in the file wrapper. Data that may be gathered is the bibliographic data on PAIR. Other data may be the data, filetype or other metadata of the documents.

At block 1104 the documents and data are processed. Processing the documents may include transforming image files into text files. Text files may mean standard text files or hybrid text and image files (i.e. drawing sheets). Not only the text but also its location on an image may be determined. This can be useful in instances where the text needs to be highlighted later. After text from a document is obtained, substantive processing begins. Substantive processing may be different for every document type. Standard forms processing may involve extracting the information out of different fields in the form. Office communications that contain user/examiner written text will have more complex substantive processing than a USPTO form. An example of more complex processing is illustrated later.

At block 1106, the data gathered is stored. This data can be indexed and classified for easier access or additional analysis. The data stored is accessed through the user interface of the IP info system, but it may be accessed by other means. In one embodiment, the data is accessed by data analytic firms or by the USPTO itself.

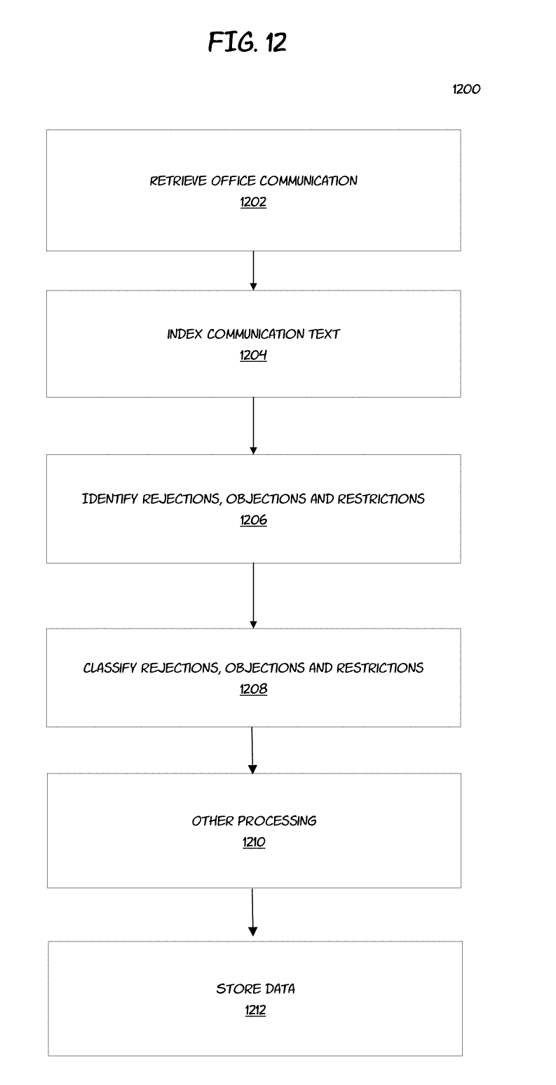

FIG. 12 illustrates a method of processing office communications in accordance with an embodiment of the present invention. At block 1202, the office communication is retrieved from a source. In one embodiment, the source is the USPTO. In other embodiments, the source can be another patent office or a secondary source. Examples of office communications are claims, office actions, appeals, petitions, remarks, amendments, restrictions, miscellaneous incoming letters, etc.

At block 1204, the communication text is indexed. Indexing should allow for a whole text search of the communication. In one embodiment, the text will not be available and will need to be obtained through optical character recognition (OCR) of images.

At block 1206, the matters are identified. Examples of matters are rejections, objections, restrictions, office requests, petitions, appeals, etc. Identifying may also comprise identifying what the matter pertains to. For example, a rejection pertains to a specific set of claims. Another example is an objection may pertain to a drawing.

At block 1208, the matter is classified. For example, a rejection may be classified by its statutory basis, MPEP section, case cited, or other identifying elements. Classifying allows a user to easily find the specific text they desire. A typical scenario is a user encounters a rejection/objection/request they have never seen and want to see an example response, a good classification should allow them to find a scenario very close to their own.

At block 1210, other processing is done on the document or data.

At block 1212, the processed data/documents are stored for later access.

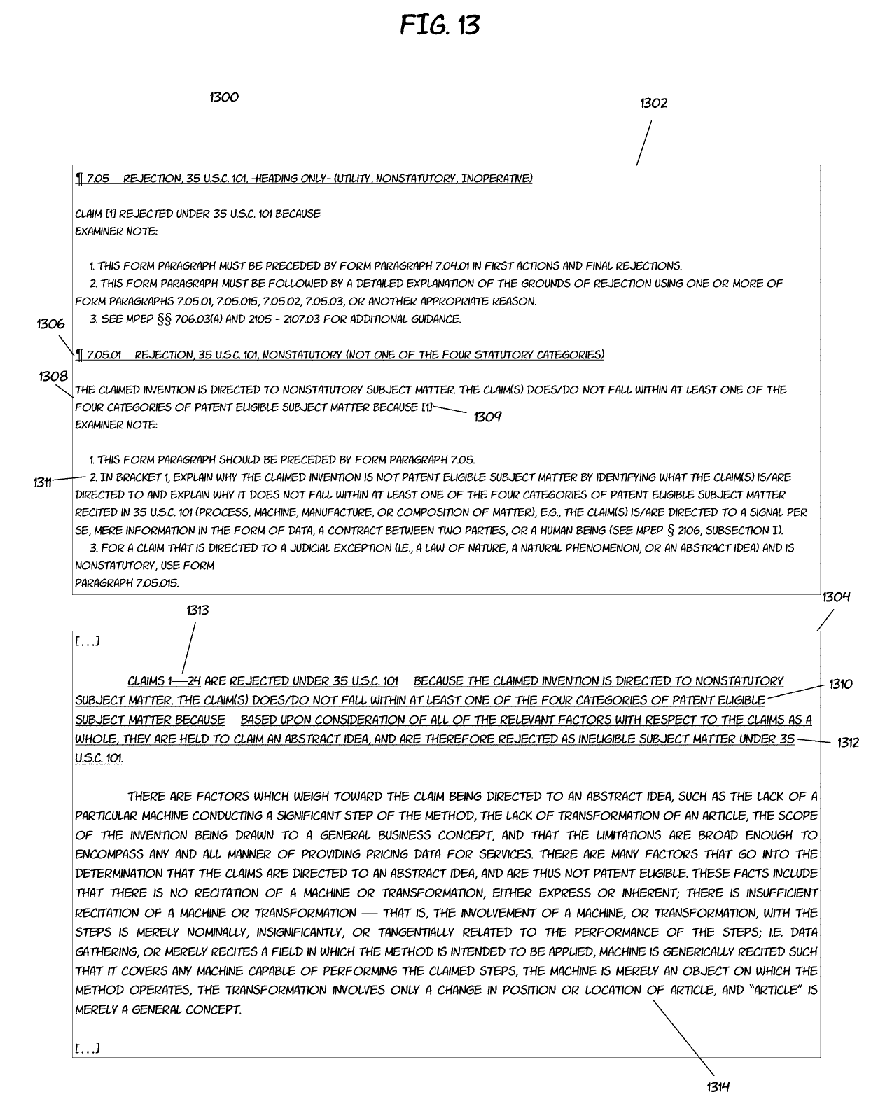

FIG. 13 illustrates a rejection identification in accordance with an embodiment of the present invention. Rejection identification 1300 is an example of a way to identify a rejection in an office action. Window 1302 illustrates a portion of MPEP 706, “Rejection of Claims.” This MPEP section is commonly used by examiners for form paragraphs to begin a rejection in an office action. The rejections are also categorically laid out in this MPEP section, which may be useful for categorizing rejections. Rejection title 1306 is the MPEP's title of a rejection. Form paragraph 1308 is provided to examiners to use in an office action. Form paragraphs 1308 normally include brackets 1309. Brackets 1309 are where the examiner customizes the rejection. Brackets 1309 have descriptions 1311 of what will be customized at that bracket 1309 which helps process information out of the rejection easier.

Window 1304 illustrates an example of a portion of an office action. Window 1304 comprises, claims 1313, rejection 1310 and explanation 1312. The components of window 1304 are identified in this example based on MPEP section 706. Claims 1313 are identified because they are a bracket 1309 of ¶ 7.05 as shown in Window 1302 and their description 1311 identifies this bracket 1309 as a claim bracket. Rejection 1310 is identified because the text follows the form paragraph 1308 of ¶ 7.05.01. Explanation 1311 is identified because they are a bracket 1309 of ¶ 7.05.01 as shown in Window 1302 and their description 1311 identifies this bracket 1309 as an explanation bracket. In the example of FIG. 13 the rejection would be classified as a “¶ 7.05.01 Rejection, 35 USC 101, Non-statutory (Not one of the four statutory categories)” rejecting claims 1-24 under the explanation of “Based upon consideration of all the relevant actors with respect to the claims as a whole they are held to claim an abstract idea and therefore rejected as ineligible subject matter.” All of these classifications are indexed and can be searched as a whole or as a part string.

FIG. 13 merely is one example of a rejection identification 1300. There may be many other ways to identify rejections. Another example of rejection identification would involve key word search of statutory, MPEP section citations or claim language. Another example of rejection identification would involve regular expression searching. Another example of rejection identification would involve fuzzy string searching.

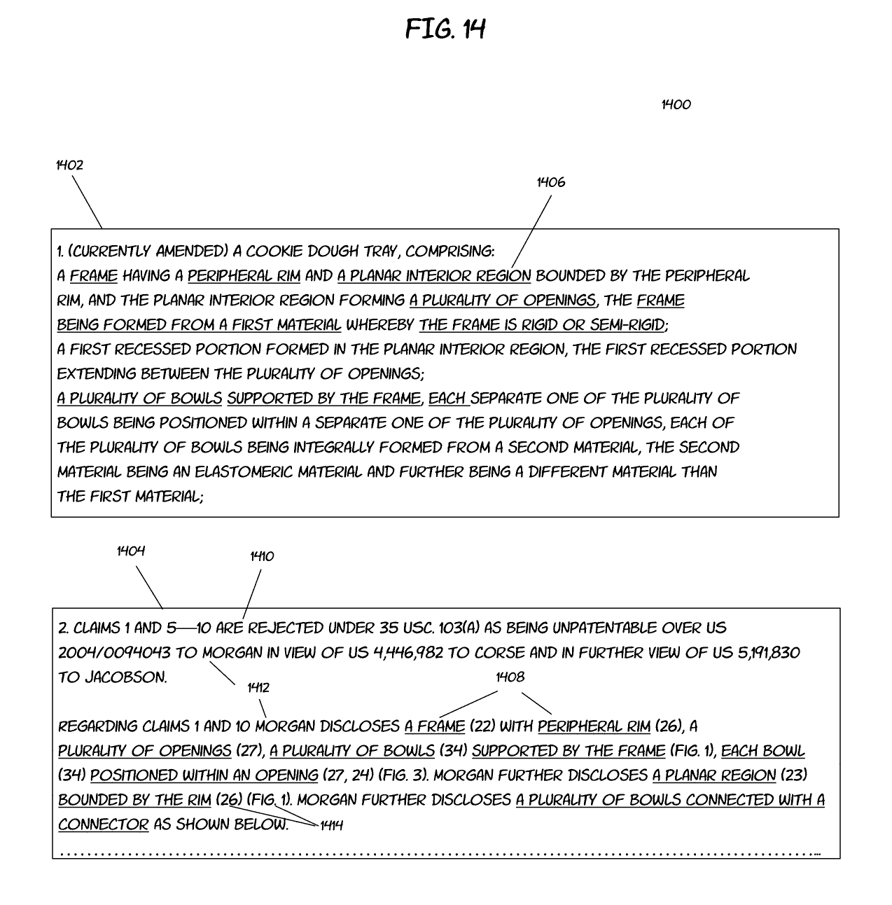

FIG. 14 illustrates claim identification in accordance with an embodiment of the present invention. Claim identification 1400 comprises claim window 1402 and rejection window 1404. Claim window 1402 illustrates an example reference claim for processing the rejection 1410 in rejection window 1404. The “claim 1” of claim window 1402 was identified based upon the rejection 1410 rejecting “claims 1-5.”

For a prior art rejection to be proper it must reject each and every limitation of a claim. To determine if the rejection of claim 1 is proper the claim is analyzed and broken into limitations 1406. Limitations 1406 may be more or less detailed than those shown in FIG. 14. In one embodiment, every word in a claim is considered a limitation 1406. In another embodiment, the words of a claim are weighted based on how limiting they are. These limitations 1406 are then compared to the rejected limitations 1408. If there is not a one-to-one correspondence of limitations 1406 to rejected limitations 1408, the rejection is not proper, under the standard above. If the IP Info System detects this while processing a rejection it may notify a person of interest for example: the user, administrator, examiner, supervisor, etc. A notification may be a message, popup, highlighting, emphasis or other known notifications.

Rejection 1410 will include references 1412 if it is a prior art rejection. In rejecting limitations 1406 rejection 1410 will cite reference portions 1414. In one embodiment, IP Info System will cross reference with the reference 1410 and highlight the reference portions 1414 for a user. The system may also highlight the limitations 1406.

In one embodiment, claim identification 1400 may work in ‘reverse.’ An examiner working on a case may highlight portions of claims 1406 and then “tag” them to a portion 1414 of a reference 1412. The IP Info System could then automatically generate a rejection. This would ensure that all limitations of a claim are properly rejected.

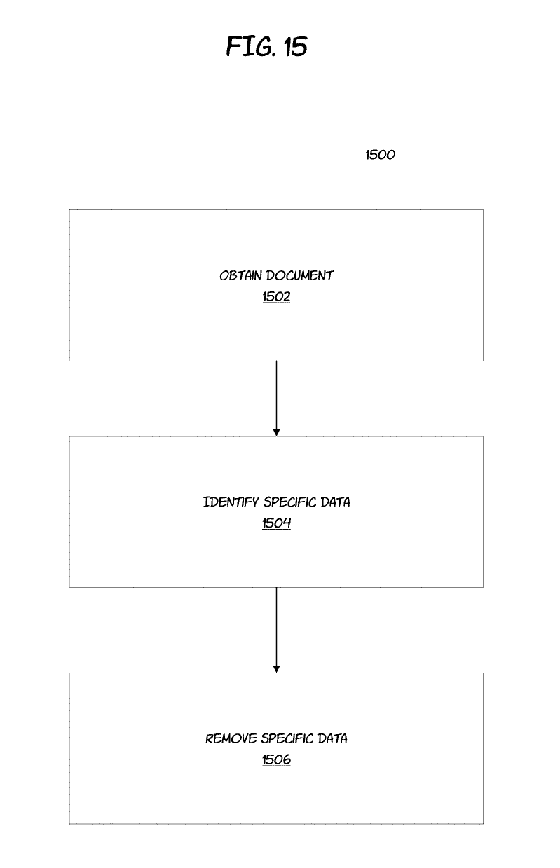

FIG. 15 illustrates a method of genericizing an office communication in accordance with an embodiment of the present invention. Method 1500 comprises, obtaining a document, identifying specific data and removing specific data. At block 1502 the document to genericized is obtained. At block 1504 the specific data is identified. Specific data would include claim numbers, claim language, prior art reference names/numbers, prior art elements, plural/singular articles etc. At block 1506 this data is removed from the document. What remains may be a fairly generic argument. The legal standard, reasoning, case citations, should all remain. In one embodiment, the specific data may be removed and replaced with an identifying place holder. For example, an argument like the one in paragraph [0091] would be genericized into paragraph [0092]:

The Office Action alleges that claim 3 is obvious under 35 U.S.C. § 103. In making the rejection, the Office Action alleged, that it would have been obvious for one of ordinary skill in the art to arrive at “a wheel of fire” by combining “wheel” of Smith with “fire” of Jones. Applicant respectfully submits that Smith teaches away from “a wheel of fire”. MPEP § 2141.02 states that “[a] prior art reference must be considered in its entirety, i.e., as a whole, including portions that would lead away from the claimed invention.” Accordingly, where cited art teaches away from a claimed feature, the cited art is not available for the purposes of an obviousness rejection.

The Office Action alleges that claim(s) [Claim] is/are obvious under 35 U.S.C. § 103. In making the rejection, the Office Action alleged, that it would have been obvious for one of ordinary skill in the art to arrive at [Claim feature] by combining [Reference Element 1] with [Reference Element 2]. Applicant respectfully submits that [Reference 1] teaches away from [Claim feature]. MPEP § 2141.02 states that “[a] prior art reference must be considered in its entirety, i.e., as a whole, including portions that would lead away from the claimed invention.” Accordingly, where cited art teaches away from a claimed feature, the cited art is not available for the purposes of an obviousness rejection.

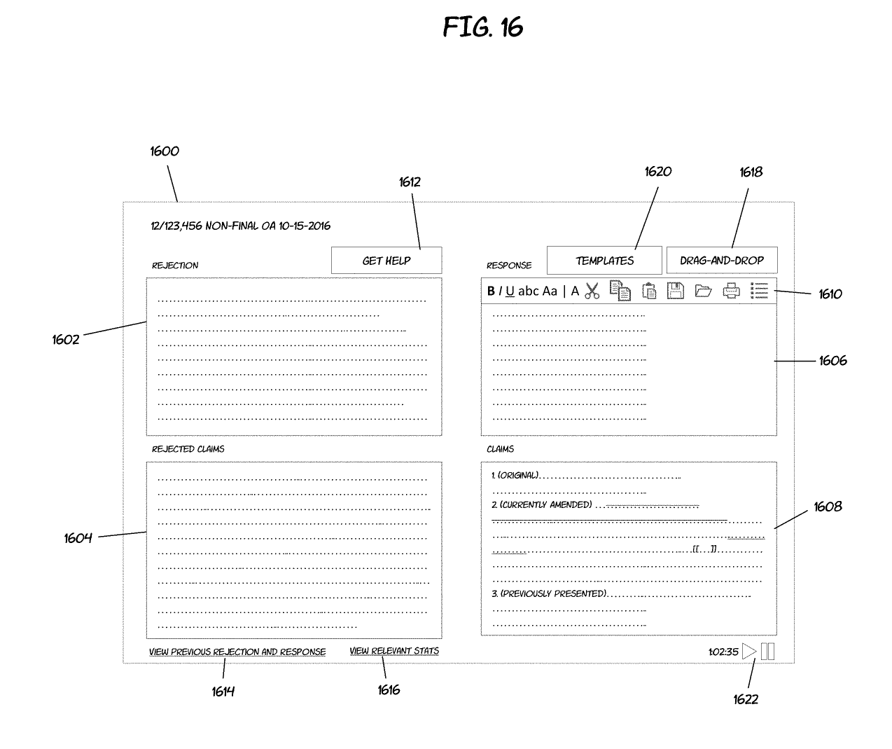

FIG. 16 illustrates a word processor in accordance with an embodiment of the present invention. As shown, environment 1600 comprises rejection text 1602, rejected claims text 1604, response 1606, claims 1608. Rejection text 1602 and rejected claims text 1604 may be copy-able, highlightable and interactive. Interactive meaning the text has links or other interactive features. Rejection text 1608 may comprise one or more rejections. Rejection text 1608 may comprise an office action, examiners appeal brief, restriction or any other office communication. Adjacent to rejection text 1608 and/or rejected claims text 1604 may be relevant links 1614 and/or 1616. In one embodiment the links are for viewing the past response and viewing the relevant statistics. Relevant statistics may be based upon the type of rejections given in the rejection text 1602.

Get help 1612 allows a user to receive help on rejection 1602. As the rejection 1602 has been process all information on it is available to the IP Info System. Get help 1612 in one embodiment may show the user similar rejections that the user has worked on. Get help 1612 in one embodiment may direct the user to someone in their law firm that has done a rejection similar to rejection 1602. Get help 1612 may give the user recommendations, for example, ‘Do an interview: statistics show that an interview with this examiner increases similar rejection overcomes by 80%’ or ‘File a Notice of Appeal: statistics show this examiner withdraws a similar rejection during appeal 70% of the time.’ Get help 1612 may give the user suggestions on claim amendments, for example ‘Average claim limitations in art unit is 45, you have 32.’

Response 1606 is a text enterable area. In one embodiment, response 1606 is a full word processor similar to Microsoft Word. Response 1606 may have a word processing toolbar 1610 that comprises known word processing tools. Drag-and-drop 1618 allows a user to insert commonly used sections of text. Commonly used sections may include, boilerplates, legal standards, argument “skeletons,” conclusions, signature block, case captions, etc. Templates 1620 allows a user to start a response based on a selected style. Styles may be catered towards specific rejections, users, clients, situations, etc. A template can comprise argument headers, boilerplates, signature blocks, drag-and-drops or whatever the user desires.

Claims 1608 is a text enterable area. In one embodiment, the area is preloaded with the most recent claim amendments and corrected claim headings (i.e. previously presented, original, etc.). As text is entered or removed from claims 1608, the heading of the modified claim may be modified appropriately, as required under MPEP 714. Also as text is entered or removed from claims 1608, the text may be underlined, stricken-through or in double brackets as required. Claims 1608 may also have a word count or limitation count for each claim. Claim limitation weight can be calculated based on many factors, for example some are: if claim is in dictionary, how often claim is used in other patent claims, if the claim is on a “taboo” list, if the claim term is defined in the specification, etc. Claim “taboo” lists can be updated constantly with the MPEP and caselaw that often give limiting weight to specific words. Based upon the broadness of a claim and the field of technology the claim is in, a value may be estimated and displayed, this value may update immediately as the user amends the claim.

Timekeeper 1622 allows a user to keep track of their time. The timekeeper 1622 may automatically run at times when a user is active on the window, or active in a window related to the case. A window related to the case may be a reference cited in a rejection 1602 or an authority cited in rejection 1602. Timekeeper 1622 may also allow a user to modify their billable time or pause the timer. In one embodiment, timekeeper 1622 runs nonstop and records what the user does for how long. This information may be useful for law firm assessment or training of a user.

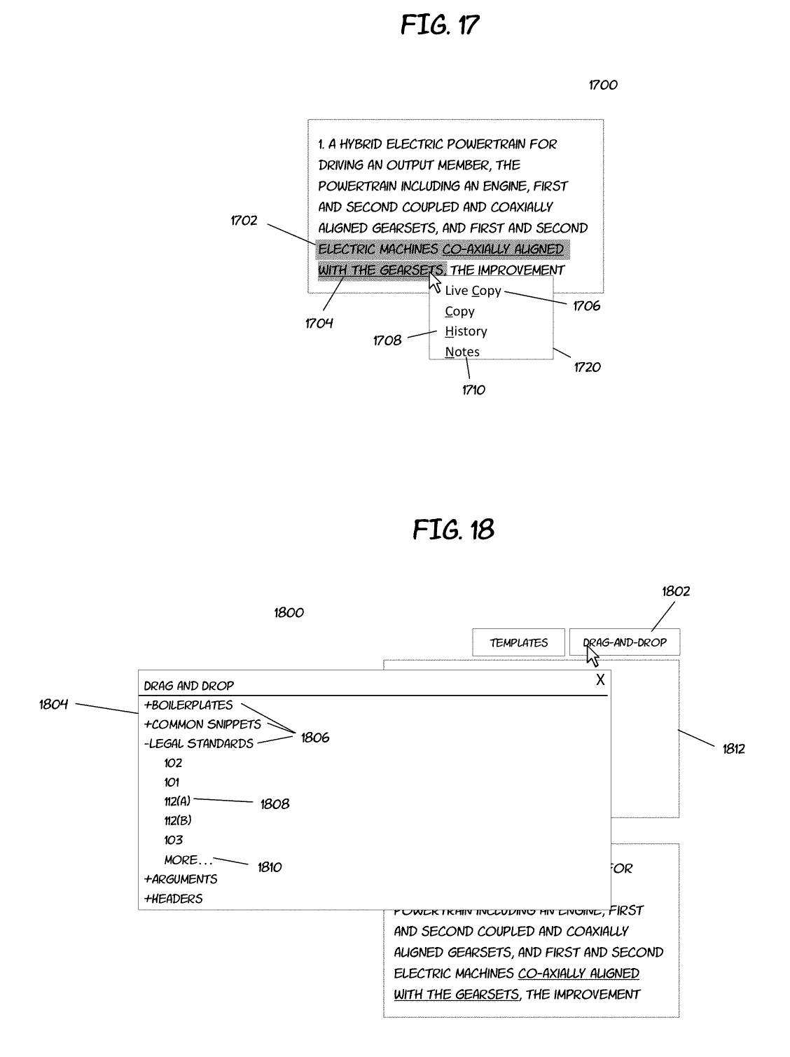

FIG. 17 illustrates a claim word processor select menu in accordance with an embodiment of the present invention. Claim environment 1700 displays a claim in an editing environment. As shown some text is highlighted or selected by highlight 1702. Highlighting/selecting text is well known. When the text is highlighted it can be right-clicked or otherwise activated and menu 1720 appears. Menu 1720 comprises options: live copy 1706, copy, history 1708 and notes 1710. In other embodiments menu 1720 may comprise fewer or greater options. Live copy 1706 allows the user to copy the currently selected text. If the selected text that was live copied changes, the location where it was pasted will also change. This is useful when a user quotes a claim in their argument but later amends the claim; if it wasn't live copied the user would manually have to find the quoted claim language and change it to the newly amended claim. If a user would forget to change the language, they might open themselves up to arguments in litigation later.

History 1708 allows a user to look at the history of the selected section of a claim. As is known, claims are normally amended from their original filing many times. It is useful to see how a claim was modified in the past in order to decide to amend it again. History 1708 may also show why the claim was amended. As an example, when a claim is rejected under a reference and subsequently amended and subsequently another rejection is issued under another reference, it can be deduced that, that amendment was to get over the first reference. Another example would be that a specific section of a claim was rejected for being indefinite and then that portion was amended and the indefinite rejection was withdrawn, it can be deduced that the amendment was to get over the indefinite rejection.

Notes 1710 allows a user to look at or create a note on the selected text. Notes 1710 are useful for transferring information to another user about the language without putting anything in the USPTO record. Notes 1710 can tie into history 1708 as well, if a user writes why they amended or removed something from the claim it can be shown in the history 1708 under why the change was made.

FIG. 18 illustrates a snippet menu in accordance with an embodiment of the present invention. Word processing environment 1800 comprises a drag-and-drop button 1802. Clicking button 1802 will make window 1804 appear. Window 1804 comprises categories 1806 and drag-and-drop 1808. Categories 1806 and drag-and-drop 1808 may be user created and customizable. Categories 1806 and drag-and-drop 1808 can be added, removed or renamed by the user. Drag-and-drops 1808 are created by the user and comprise a segment of text. The text may be formatted as like by the user. The text may also include images. A drag-and-drop 1808 when activate will paste the segment of text into the working document 1812. A user may have drag-and-drops 1808 that relate to many different things, for example legal standards, arguments, boilerplates, etc.

In one embodiment, a user's drag-and-drop 1812 text has all of its legal citing authority checked against a database. If the legal authority cited is no longer good law the user will be notified. For example, the MPEP is occasionally modified and sections moved, some firms use the same arguments over and over and might not notice immediately that the section has moved and they are citing the wrong section. Another example is a case that is commonly cited might have been overruled, to prevent a user from having to constantly check caselaw a database such as Westlaw can be checked to see if the case is still “good law.” Along the same lines a user may have standards for pre-AIA law and post-AIA, IP Info system will notify a user if they are using the correct standard for the working case. In one embodiment, only the relevant standards will be show (i.e. if it is an older case only pre-AIA related drag-and-drops 1808 will be shown).

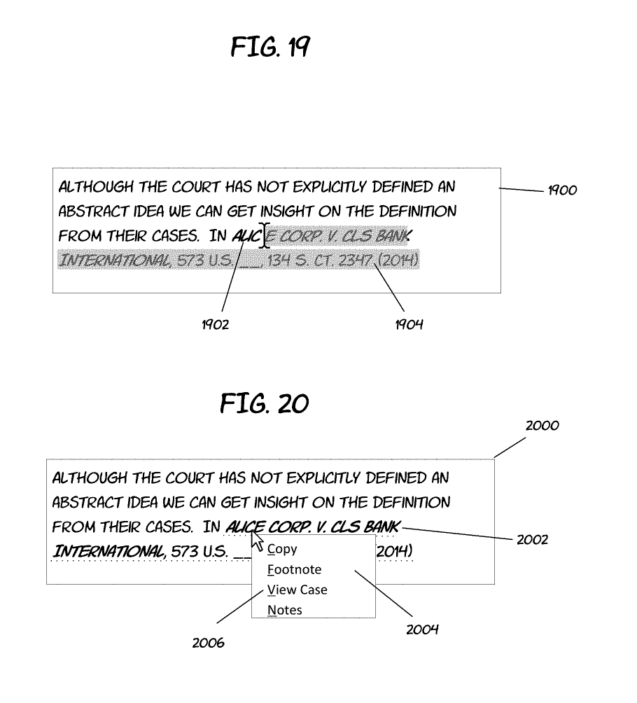

FIG. 19 illustrates an autocomplete feature in accordance with an embodiment of the present invention. Working environment 1900 comprises written text 1902 and autocompleted text 1904. Written text 1902 is the text that a user has begun to type. Autocompleted text 1904 is the text that is generated in response to the written text 902. The autocompleted text 1904 may be generate solely due to typing written text 1902. In another embodiment, the user must initiate the autocomplete feature before autocompleted text 1904 appears. This initiation could be a key command or other input. The autocompleted text 1904 may be generate based upon the argument currently being worked on. This would mean that only cases or authorities related to the argument being made would be shown and others filtered out. In one embodiment, the autocomplete feature works in the claim word processor and autocompletes claim language to ensure consistent claim feature language.

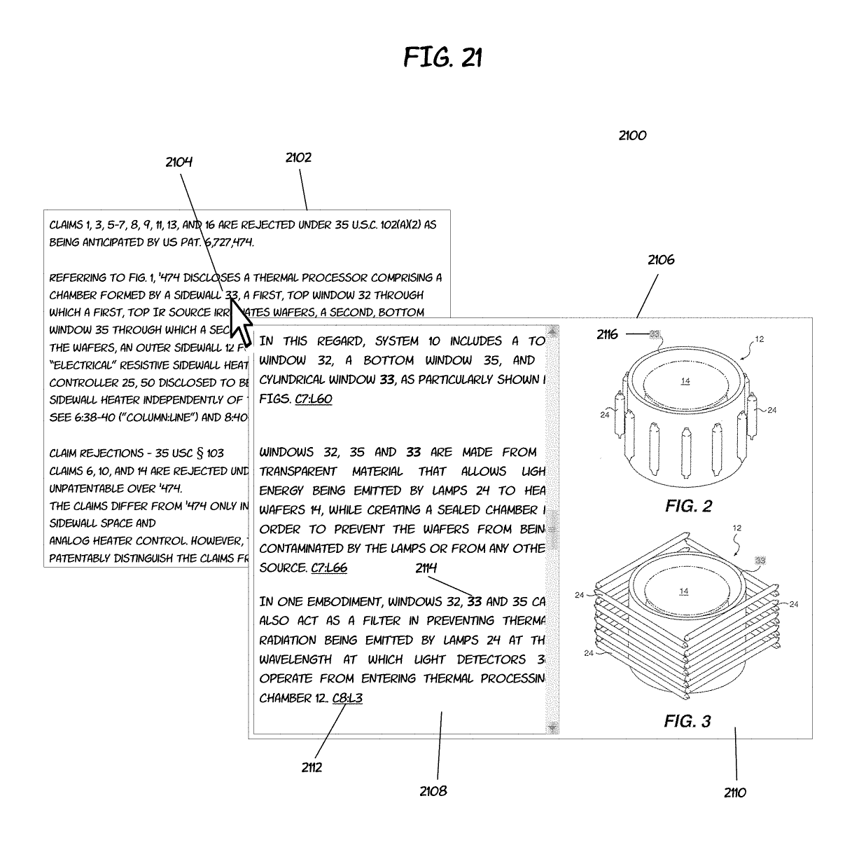

FIG. 20 illustrates a reference select menu in accordance with an embodiment of the present invention. Working environment 2000 comprises citation 2002 and popup 2004. Citation 2002 may be any citation of authority or prior art in a document. Right-clicking or otherwise activating citation 2002 may generate a popup 2004 or other notification. Popup 2004 may show an option to view the authority 2006 and/or show if the authority is still “good law.” It may also show related references or references that are successfully used to counter the reference.

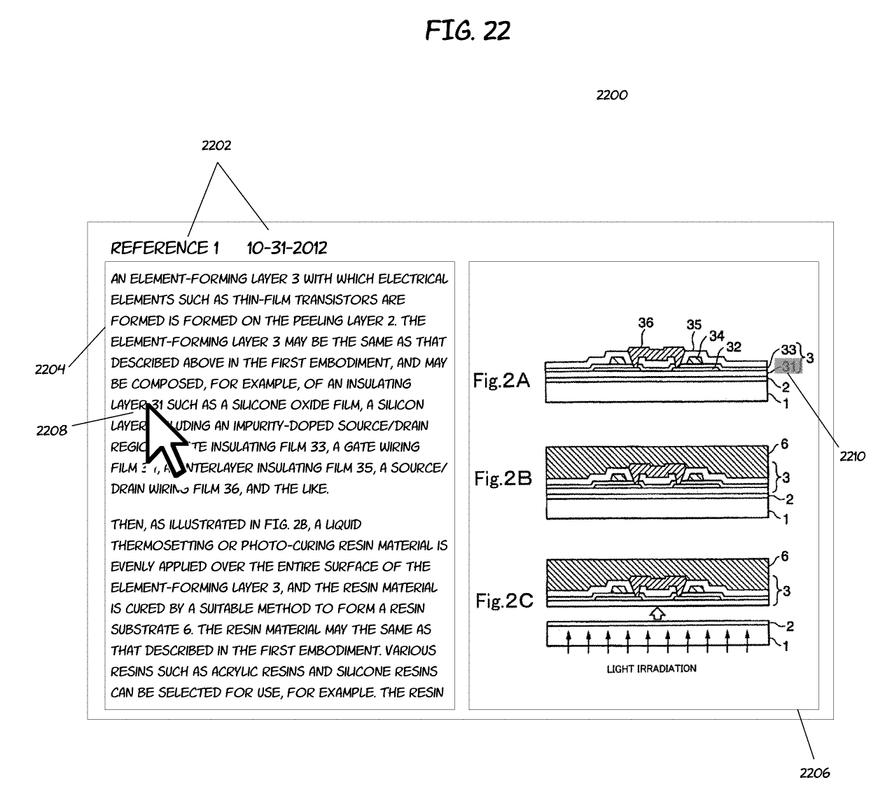

FIG. 21 illustrates a reference aide in accordance with an embodiment of the present invention. Working environment 2100 comprises a document viewer 2102 and an overlay 2106. Document viewer 2102 may display any patent related document. Some examples are office actions, rejections, restrictions, petitions, responses, briefs, etc. Document viewer may comprise various citations 2104. As shown to citation 2104 is a reference number of a cited piece of prior art. Citation 2104 may also be authority citations such as cases, claims, MPEP sections, USPTO documents or prior art citations such as patents, publications, figures, page numbers, column and lines, paragraphs, reference numbers, etc.

Citations 2104 may be activated by a user to provide additional information. Activation may be clicking, hovering, rollover, touchpad tapping or otherwise user interaction with citation 2104. As shown the user has activated citation 2104 causing overlay 2106 to appear. Overlay 2106 may be a popup, new window or another visual display. As shown overlay 2106 comprises a text portion 2108 and an image portion 2110. Text portion 2108 as shown displays every occurrence of the citation 2104 in the reference specification from which it comes. Image portion 2110 as shown displays every occurrence of the citation 2104 in the reference figures from which it comes. As shown citation 2104 is reference number “33” from U.S. Pat. No. 6,727,474, therefore the text portion 2108 and image portion 2110 are populated from this patent's specification and figures respectively. This feature may be useful to a user because it allows the user to quickly check the cited portions of a cited reference without having to “dig.” A user may be able to quickly identify an examiner's misunderstanding of claim language by noticing citation 2104 is not analogous to the claim language it is supposed to support a rejection on. A user may also be able to determine that citation 2104 of a reference does anticipate/teach the claim language, which means they may have to amend the claim language to distinguish from citation 2104.

Text portion 2108 may show every instance where citation 2104 is in its reference. An instance may require some context so a portion of text around the subject of citation may also be shown. For example, every sentence or paragraph where the citation 2104 appears in a reference may be shown. In one embodiment, less than every instance of the citation 2104 in its reference is shown. Text portion 2108 may also display the location 2112 of the instance. Location 2112 may be a link to the location 2112 in the full text of the reference. Text portion 2108 may also provide emphasis 2114 on the subject of citation 2104. Emphasis 2114 may comprise highlighting, underlining, bolding, haptic feedback, or other methods of emphasis. This allows a user to quickly see where in the text the citation 2104 is located.

Similarly, image portion 2110 may comprise an emphasis 2116 on the subject of citation 2104. Emphasis 2116 may comprise highlighting, zooming, underlining, bolding, haptic feedback, or other methods of emphasis. Emphasis 2116 may emphasize the reference number in the image. Emphasis 2116 may also emphasize the actual portion the reference number refers to. For example, a reference number often accompanies an arrow or line to an object, in one embodiment the line and/or object are also emphasized. This is especially useful when the subject is located in a complex figure with many disorganized reference numbers. Image portion 2110 may show the entire figure/drawing in which the subject is located or it may only show a portion of a figure/drawing.

FIG. 22 illustrates a reference page in accordance with an embodiment of the present invention. Working environment 2200 comprises an identification portion 2202, a text portion 2204 and an image portion 2206. Identification portion 2202 comprises information that allows a user to identify what page they are on. Identification portion 2202 can comprise a publication number, patent number, inventor name, date, etc.

Text portion 2204 comprises the text of the reference. For example, the text of a patent reference is the specification and claims. Text portion 2204 may be formatted, interactive and/or plain text. Text portion 2204 may also include images if the reference has images within its text. Interactive aspects of text portion 2204 may include features 2208, citations to other documents, etc. Activating feature 2208 may cause all other references to that feature 2208 to also be emphasized in text portion 2204. Activating feature 2208 may also generate an overlay similar to the overlay 2106 of FIG. 21. Activating feature 2208 may also emphasize the corresponding feature 2110 of image portion 2206. If the feature 2208 is not on the current image of image portion 2206, the image of image portion 2206 may seek to an image that has a corresponding feature 2210 to feature 2208. These features may be useful in quickly understanding a reference.

Image portion 2206 comprises an image or the images of the reference. For example, the images of a patent reference would be its figures/drawings. All of a references images may be shown at once on image portion 2206. One or more images of a reference may be shown on image portion 2206. In one example, thumbnails of a references images are displayed on image portion 2206 and activating one of the thumbnails enlarges the image to the full size of image portion 2206. Image portion 2206 may be zoomed or copied. It may be useful to a user to copy a portion of an image and paste it into their argument for explanation. Copying a portion of the image may be freehand, rectangular, automatically targeted for a reference object or otherwise selected by the user. Image portion 2206 comprises features 2210. As shown feature 2210 is emphasized because its corresponding feature 2208 in the text is activated. This operation could work in reverse, for example feature 2210 is activated and hence all corresponding features 2208 in the text would be emphasized.

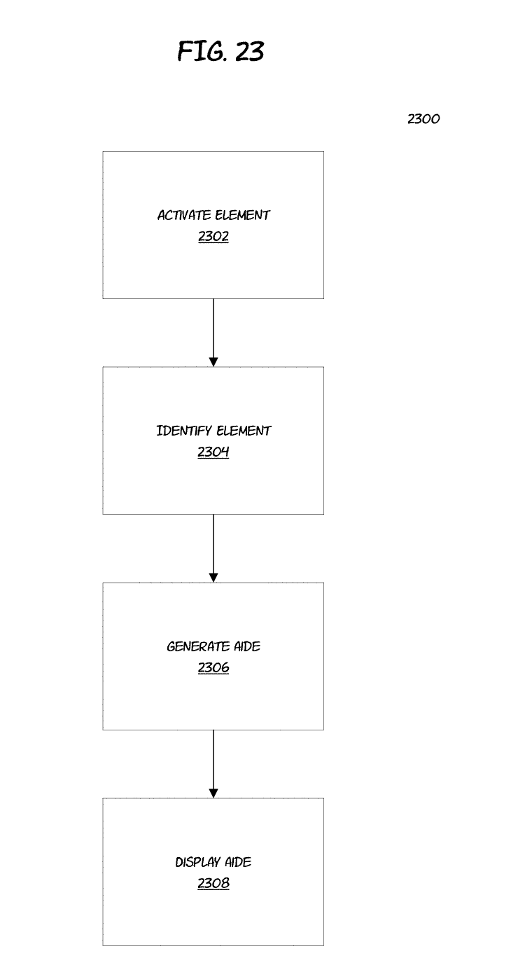

FIG. 23 illustrates a method of generating an aide in accordance with an embodiment of the present invention. Method 2300 comprises blocks 2302-2308. At block 2302 an element is activated. An element can be any portion of any patent related document. For example an element may a portion of a figure, an object with a reference number, a term, or portion of a prior art reference. Activating an element can be done in many different ways. For example, clicking, hovering, rolling over, tapping, swiping or otherwise activated through user input.

At block 2304 the element is identified. Identifying an element may involve accessing a database of processed references. In one embodiment, a database of prior art references has preprocessed references with its elements, figures and text indexed or catalogued. A processed reference would have its elements linked to all other similar elements in the document. For example, in a car patent every instance of ‘wheel 300’ would be linked to all other instances of ‘wheel 300.’ This example may be expanded to include all instances of ‘wheel’ and/or reference number ‘300.’ It could be further expanded to identify the object in a figure which ‘300’ identifies and find other similar looking objects in the figures.

In another embodiment, the reference is not preprocessed and needs to be processed “on the fly.” A simplified process of this would be to search the text and image for instances of the element's name or reference number.

At block 2306 an aide is generated based on the identified element. The aide may be a small tooltip. The aide may be an overlay similar to the overlay 2106 in FIG. 21. The aide may be a popup window or a redirect to a new page. The aide may give the user more information on the identified. In one embodiment, the aide provides a summary of the identified element. In one embodiment, the aide shows every instance of the element in the reference. In one embodiment, the aide shows the claim language that the identified element is cited to reject. At block 2308 the generated aide is displayed.

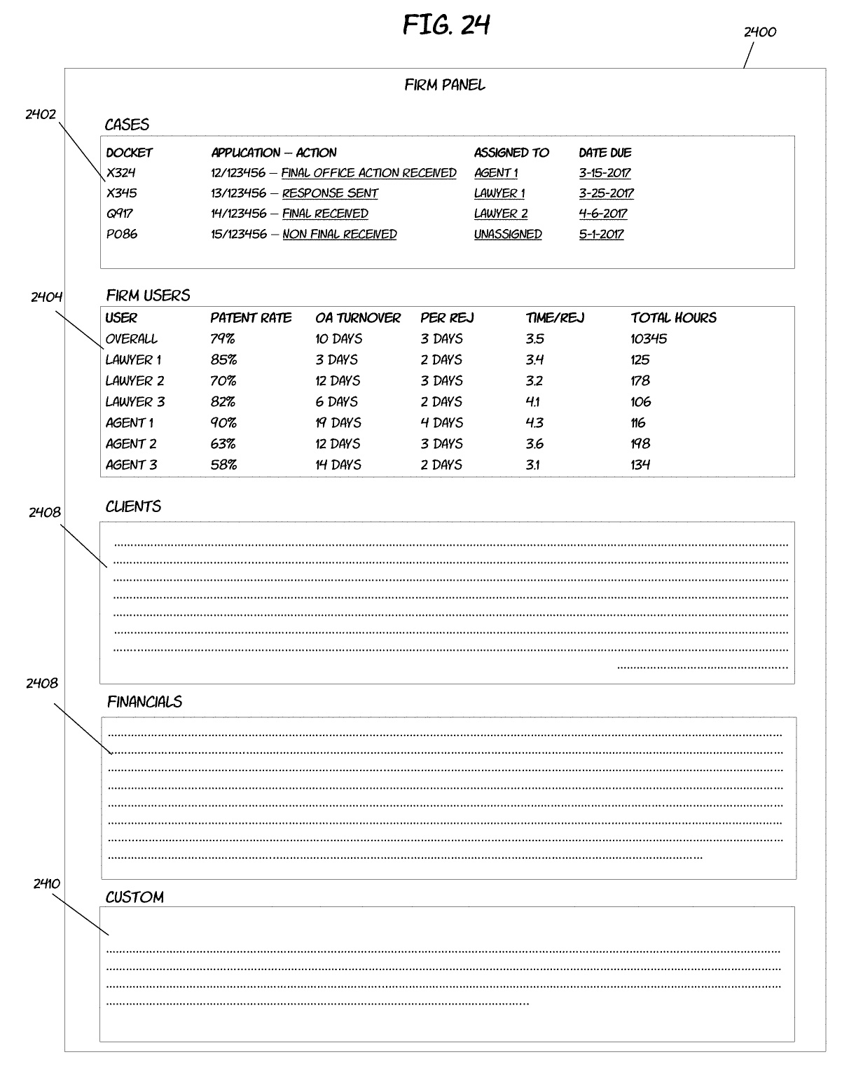

FIG. 24 illustrates a firm page in accordance with an embodiment of the present invention. Working environment 2400 comprises cases 2402, users 2404, financials 2406, clients 2408 and custom 2410. Cases 2402 may display a list of cases that the firm is handling. Cases 2402 may also display cases that the firm is watching. Cases can have their information displayed in different columns. The user may change which columns are shown and can sort the cases by the selected columns. The columns displayed are examples and more or less information can be columnized. Cases 2402 may function as a firm docket.

Firm users 2404 may display a list of the users that work at the firm. Firm users 2404 may also display users that the firm is watching. Users can have their information displayed in different columns. The user may change which columns are shown and can sort the users by the selected columns. The columns displayed are examples and more or less information can be columnized.

Clients 2406 may display a list of the users that work at the firm. Clients 2406 may also display clients that the firm is watching. Clients can have their information displayed in different columns. The user may change which columns are shown and can sort the clients by the selected columns. The columns displayed are examples and more or less information can be columnized.

Financials 2408 may display financial data of the firm. Information that is shown here may include billing, rates, income, expenses, payroll, etc. This information may be tied into another financial software such as Quickbooks. In one embodiment, the hours worked and billing rates are automatically exported from the IP Info Sytem to a user's billing software. Custom 2410 comprises an area where a user can integrate with a program, website or other application. One example of a custom integration would be an external docketing system.

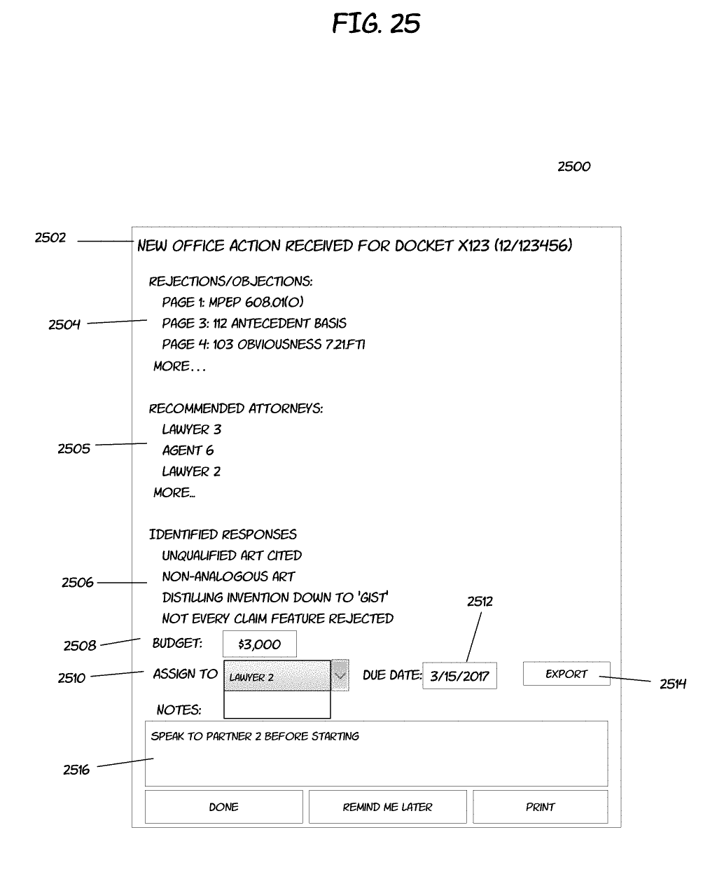

FIG. 25 illustrates a new office communication page in accordance with an embodiment of the present invention. Environment 2500 comprises id portion 2502, matter portion 2504, attorney portion 2505, response portion 2506, budget portion 2508, assignment portion 2510, due date portion 2512, export portion 2514 and notes 2516.

Id portion 2502 comprises information that identifies the received document. The information provided in id portion 2502 may comprise the docket number, client, application number, document type (office action, restriction, etc..), date received, etc.

Matter portion 2504 comprises a list of matters in the office communication. For example, if the matter is an office action, it is processed and all of the rejections/objections will be shown in matters portion 2504. The matters listed in matters portion 2504 may be activated to show more information. Activation may comprise showing a popup or other visual indication.

Attorney portion 2505 comprises a list of recommended users to assign on the received office communication. The recommendations may be made based on a variety of criteria comprising: users work load, experience, user's history on the case, predictions of workload from other cases the user is working on, rejection experience, etc. A user's history on the case may mean they drafted the application, helped on the case, drafted a previous response, etc. Predictions of workload from other cases means that it looks at cases the user is working on that currently have no actions pending and looks at the average time between actions of that case (including examiner, art unit, etc. averages) and determines if there is a likelihood of many actions arriving at one time. Rejection experience may mean that a user has done a rejection that is similar to the one in the received office action.

Response portion 2506 comprises a list of responses that have been statistically or otherwise identified to be successful against a matter in the office communication. Examples of easily identified responses are unqualified art (i.e. art published after the current application filing) or not every claim feature is rejected (see above). Another example of a identified response would be premature office action finality.

Budget portion 2508 comprises the budget for this assignment. The budget can be set by the client, user or a firm administrator.

Assignment portion 2510 comprises the selection of users to assign the office communication response to. Assignment can be to a user, multiple users or groups of users. Due Date 2512 comprises a due date for the assignment. The due date can be a single date or can be multiple dates for multiple stages of completion of the assignment. Export 2514 comprises a feature to export the assignment to an external docketing system. Notes 2516 allows a user to leave a note on the assignment for another user to see. Notes 2516 could comprise instructions for response to the assignee.

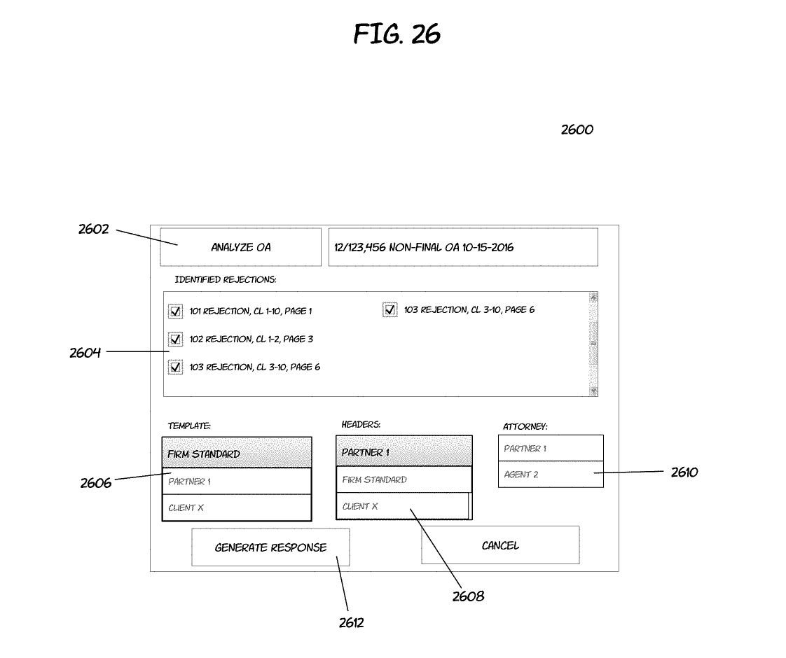

FIG. 26 illustrates a response generator in accordance with an embodiment of the present invention. Environment 2600 comprises: communication loader 2602, matters list 2604, template select 2606, header select 2608 and block select 2610. Communication loader 2602 is where a user selects a USPTO office communication to be analyzed. Once analyzed the matters identified in the communication are loaded into matters list 2604. A user can select matters from the matters list 2604 to have responses generated for those matters. Template select 2606 is where the user selects a template for the generated response to follow. Header select 2608 is where the user selects the format of headers that will be generated in the response. Block select 2610 is where the user selects the signature block that will be placed at the end of the generated response. Activating button 2612 will generate the response based upon the selected criteria. In other embodiments, there may be fewer or lesser criteria for the user to select.

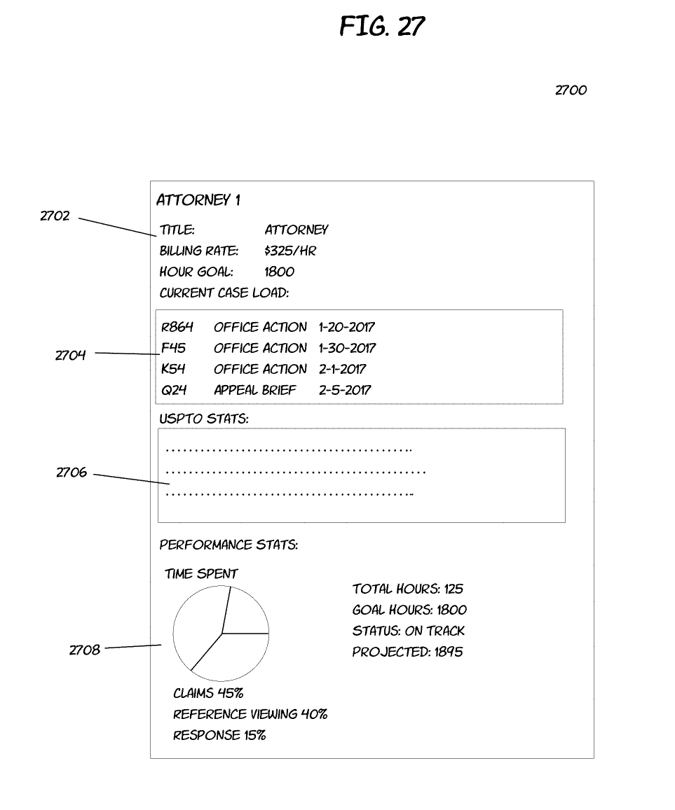

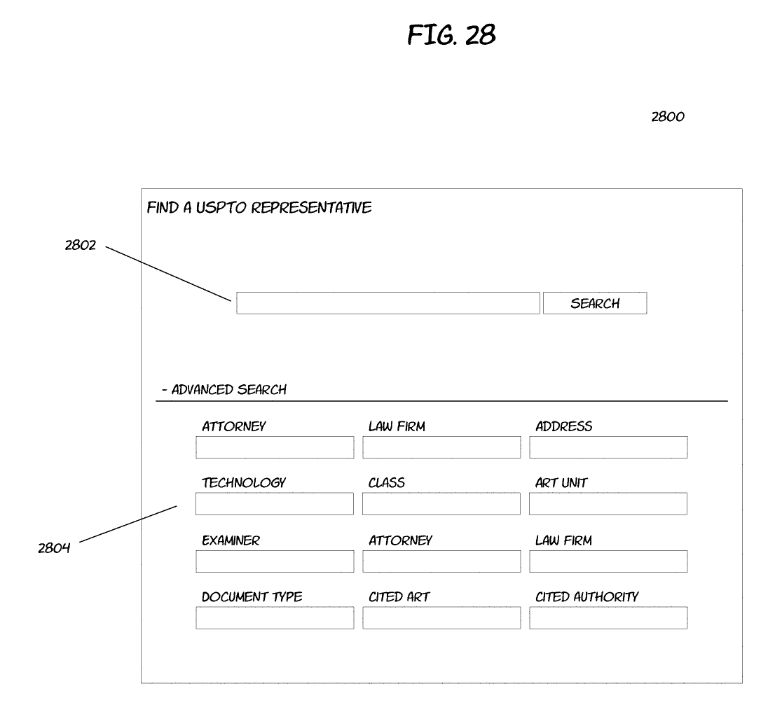

FIG. 27 illustrates an agent performance page in accordance with an embodiment of the present invention. Environment 2700 comprises: basic info 2702, cases 2704, uspto statistics 2706 and performance stats 2708. Basic info 2702 may comprise general bibliographic information on the user. Basic info 2702 may comprise the data shown and may also comprise background information on the user such as age, school, registration number, address, phone number, email, etc.

Cases 2704 may comprise information relating to the cases the user is working on or has worked on. They may be clickable links that show more information when activated. Cases 2704 may show columns of data indicative of the case such as docket number, client, due date, application number, office communication type, etc.

USPTO statistics 2706 may comprise information relating to the statistics of the user at the USPTO. This information may comprise USPTO Office of Enrollment and Discipline data, patent rate, abandon rate, total cases worked on, appeals, response time etc.

Performance stats 2708 may comprise information relating to the user's performance within the IP information System. Various tasks can have their time tracked in order to see what a user does during a day. This may be valuable for training. For example, some new patent attorneys spend an extended amount of time reading cited references, when only a brief glance at the cited portion would reveal the reference does not teach what is asserted in a rejection.

FIG. 28 illustrates a patent representative search in accordance with an embodiment of the present invention. Environment 2800 comprises a standard search 2802 and an advanced search 2804. Standard search 2802 may break the input into individual words and search them across all data stored on a user. Advanced search 2804 may allow a user to search specific fields for a patent representative.

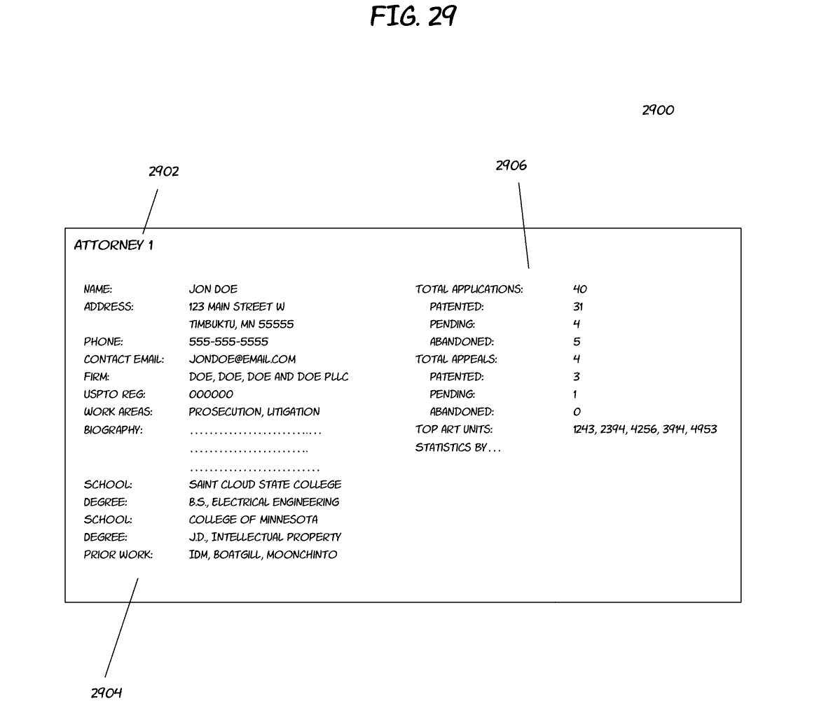

FIG. 29 illustrates a patent representative's page in accordance with an embodiment of the present invention. Title 2902 displays the patent representatives name, which may be a person or an organization (law firm). Biographic information 2904 comprises basic biographic on the patent representative. This information may be provided by the user or obtained from a secondary source (i.e. patent office OED). Patent statistics 2906 comprises the users statistics at the patent office. This data can be displayed in a number of ways including but not limited to: as raw data, as percentages, as percentages vs average, as percentages vs averages in specific fields (i.e. art units, tech fields, classes, etc.). The ability to weight statistics by field may be very useful as some fields are more difficult to patent in than others.

The default mode of displaying data may be raw data. However, a patent representative, if subscribed, may chose how the data on their profile is displayed. They may also be able to add custom fields that may be of interest to a client looking for a representative. Some of these fields may be published works, blogs, recommendations from other users, etc. Recommendations from another subscribed user may appear as links to their representative profile.

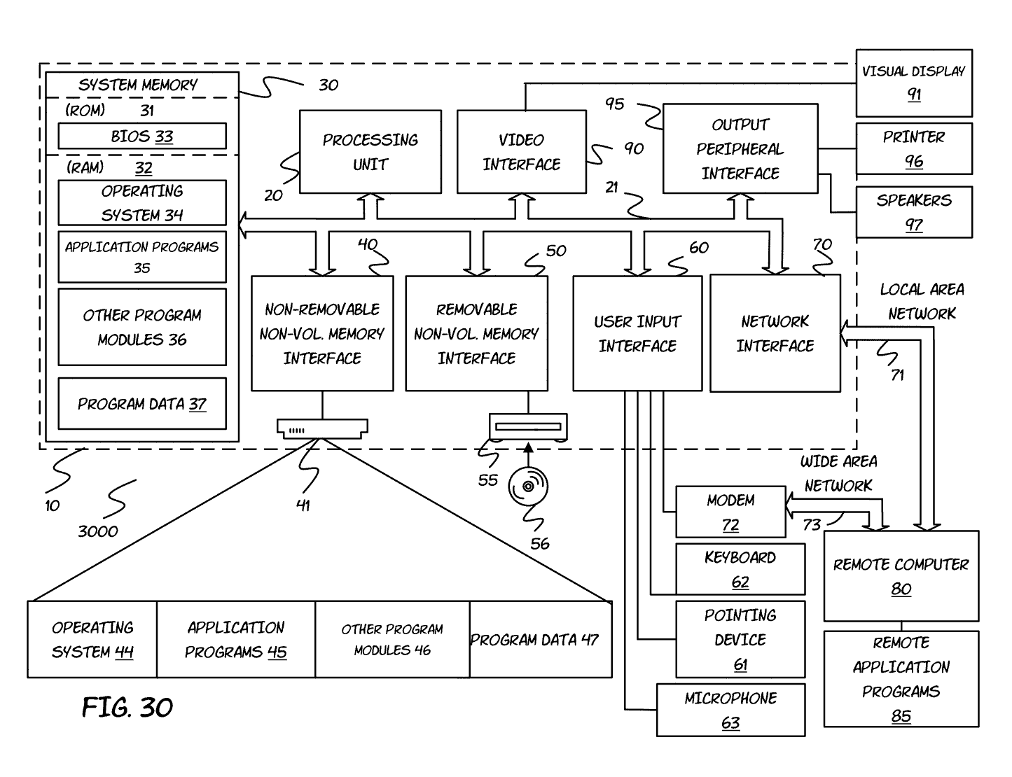

FIG. 30 is one example of a computing environment in which architecture 100 and/or 300, or parts of them, (for example) can be deployed. With reference to FIG. 30, an example system for implementing some embodiments includes a general-purpose computing device in the form of a computer 10. Components of computer 10 may include, but are not limited to, a processing unit 20 (which can comprise processors or servers from previous Figures), a system memory 30, and a system bus 21 that couples various system components including the system memory to the processing unit 20. The system bus 21 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIGS. 1 and/or 6 can be deployed in corresponding portions of FIG. 30.

Computer 10 typically includes a variety of computer readable media. Computer readable media can be any available media that can be accessed by computer 10 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 10. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 30 includes computer storage media in the form of volatile and/or nonvolatile memory such as read only memory (ROM) 31 and random access memory (RAM) 32. A basic input/output system 33 (BIOS), containing the basic routines that help to transfer information between elements within computer 10, such as during start-up, is typically stored in ROM 31. RAM 32 typically contains data and/or program modules that are immediately accessible to and/or presently being operated on by processing unit 20. By way of example, and not limitation, FIG. 30 illustrates operating system 34, application programs 35, other program modules 36, and program data 37.

The computer 10 may also include other removable/non-removable volatile/nonvolatile computer storage media. By way of example only, FIG. 30 illustrates a hard disk drive 41 that reads from or writes to non-removable, nonvolatile magnetic media, and an optical disk drive 55 that reads from or writes to a removable, nonvolatile optical disk 56 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 41 is typically connected to the system bus 21 through a non-removable memory interface such as interface 40, and optical disk drive 55 are typically connected to the system bus 21 by a removable memory interface, such as interface 50.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOC s), Complex Programmable Logic Devices (CPLDs), etc.

The drives and their associated computer storage media discussed above and illustrated in FIG. 30, provide storage of computer readable instructions, data structures, program modules and other data for the computer 10. In FIG. 30, for example, hard disk drive 41 is illustrated as storing operating system 44, application programs 45, other program modules 46, and program data 47. Note that these components can either be the same as or different from operating system 34, application programs 35, other program modules 36, and program data 37. Operating system 44, application programs 45, other program modules 46, and program data 47 are given different numbers here to illustrate that, at a minimum, they are different copies.

A user may enter commands and information into the computer 10 through input devices such as a keyboard 62, a microphone 63, and a pointing device 61, such as a mouse, trackball or touch pad. Other input devices (not shown) may include a joystick, game pad, satellite dish, scanner, or the like. These and other input devices are often connected to the processing unit 20 through a user input interface 60 that is coupled to the system bus, but may be connected by other interface and bus structures, such as a parallel port, game port or a universal serial bus (USB). A visual display 91 or other type of display device is also connected to the system bus 21 via an interface, such as a video interface 90. In addition to the monitor, computers may also include other peripheral output devices such as speakers 97 and printer 96, which may be connected through an output peripheral interface 95.

The computer 10 is operated in a networked environment using logical connections to one or more remote computers, such as a remote computer 80. The remote computer 80 may be a personal computer, a hand-held device, a server, a router, a network PC, a peer device or other common network node, and typically includes many or all of the elements described above relative to the computer 10. The logical connections depicted in FIG. 30 include a local area network (LAN) 71 and a wide area network (WAN) 73, but may also include other networks. Such networking environments are commonplace in offices, enterprise-wide computer networks, intranets and the Internet.

When used in a LAN networking environment, the computer 10 is connected to the LAN 71 through a network interface or adapter 70. When used in a WAN networking environment, the computer 10 typically includes a modem 72 or other means for establishing communications over the WAN 73, such as the Internet. The modem 72, which may be internal or external, may be connected to the system bus 21 via the user input interface 60, or other appropriate mechanism. In a networked environment, program modules depicted relative to the computer 10, or portions thereof, may be stored in the remote memory storage device. By way of example, and not limitation, FIG. 30 illustrates remote application programs 85 as residing on remote computer 80. It will be appreciated that the network connections shown are exemplary and other means of establishing a communications link between the computers may be used.

Although the present invention has been described with reference to preferred embodiments, workers skilled in the art will recognize that changes may be made in form and detail without departing from the spirit and scope of the invention.

What is claimed is:

1. An intellectual property information system comprising:
a word processing portion;
an office action viewing portion comprising a cited reference link configured to be activated by a user;
wherein in response to activating the cited reference link, a summary of the cited reference link is generated; and
wherein the word processing portion, office action viewing portion and the summary are generated by a processor of a computing device and displayed on a display.
